(19) United States
(12) Patent Application Publication
(10) Pub. No.: US 2026/0329430 A1
(43) Pub. Date: Oct. 22, 2026

(54) CALCULATOR WITH HANDWRITING PAD

(71) Applicant: Shenzhen Xin Niu E-commerce Co., Ltd, Shenzhen (CN)

(72) Inventor: YINGBIN ZHANG, Shenzhen (CN)

(21) Appl. No.: 19/720,901

(22) Filed: Jun. 26, 2026

Related U.S. Application Data
(63) Continuation-in-part of application No. 18/969,991, filed on Dec. 5, 2024, now Pat. No. 12,717,371.
Application No. 18/969,991 is a continuation-in-part of application No. 18/739,704, filed on Jun. 11, 2024, now Pat. No. 12,197,376.

(30) Foreign Application Priority Data
Jun. 3, 2024 (CN) 202421258755.7

(51) Int. Cl. G06F 3/04883; G06F 1/16; G06F 3/0354

(52) U.S. Cl. CPC G06F 3/04883; G06F 1/1618; G06F 3/03545; G06F 2200/1632

(57) ABSTRACT

A calculator with a handwriting pad includes a first device, a second device, and a stylus pen. The first device is one of a calculator unit and a handwriting pad unit, and the second device is the other of the calculator unit and the handwriting pad unit. The second device is provided with hanging openings, and the first device is provided with hanging members adapted to the hanging openings. When the hanging members are arranged in the hanging openings, the first device and the second device are in a horizontally unfolded state. The stylus pen is adapted for use with the handwriting pad unit. The stylus pen is provided with an adapting portion adapted to the hanging opening or the hanging member, and the adapting portion is a hanging opening or a hanging member.

### CROSS-REFERENCE TO RELATED APPLICATIONS

This application is a continuation in part of U.S. application serial No. 18/969, 991, filed on Dec. 5, 2024, the content of which is incorporated by reference herein.

### TECHNICAL FIELD

The present disclosure relates to the technical field of calculator units, and in particular to a calculator with a handwriting pad.

### BACKGROUND

When performing calculations, a user typically computes the required numerical values on a notepad, and then verifies the results using a calculator unit. In addition, users often employ a handwriting pad unit for doodling or as a reusable draft sheet. Therefore, calculators with a handwriting pad have emerged on the market, in which the handwriting pad unit is rotatably connected to the calculator unit. During use, the handwriting pad unit and the calculator unit are unfolded, so as to use both units. When not in use, the handwriting pad unit and the calculator unit are folded together for convenient storage. However, for such a calculator, the calculator unit and the handwriting pad unit must be carried together, as they are non-detachable, failing to meet the user’s need to carry the calculator unit or the handwriting pad unit independently. Moreover, when unfolded, the handwriting pad is generally positioned only on the right side of the calculator unit, which makes it inconvenient for left-handed users, as they are prone to pressing the keys on the calculator unit while using the handwriting pad.

### SUMMARY

The main object of the present disclosure is to provide a calculator with a handwriting pad, so as to solve the problem in the prior art that the calculator unit and the handwriting pad unit are non-detachable, resulting in the inability to carry the calculator unit or the handwriting pad unit independently, and to solve the problem that the handwriting pad is generally located only on the right side of the calculator unit, making it inconvenient for left-handed users.

In order to solve the above technical problems, the present disclosure provides the following technical solution.

The present disclosure provides a calculator with a handwriting pad. The calculator with a handwriting pad includes a first device, a second device, and a stylus pen.

The second device is provided with hanging openings on both side walls or at positions adjacent to both side walls of the second device. The first device is provided with hanging members adapted to the hanging openings on both side walls or at positions adjacent to both side walls of the first device.

When the hanging members are arranged in the hanging openings, the first device and the second device are in a horizontally unfolded state.

The first device is one of a calculator unit and a handwriting pad unit, and the second device is the other of the calculator unit and the handwriting pad unit.

The stylus pen is adapted for use with the handwriting pad unit. The stylus pen is provided with an adapting portion adapted to the hanging opening or the hanging member. The adapting portion is a hanging opening or a hanging member.

The present disclosure has the following beneficial effects. Compared with the prior art, the present disclosure provides hanging members and hanging openings. When the hanging members are arranged in the hanging openings, the first device and the second device are connected, that is, the calculator unit and the handwriting pad unit are connected, thereby preventing the calculator unit and the handwriting pad unit from separating during use. When a user needs to carry the calculator unit or the handwriting pad unit independently for use, the hanging members can be disengaged from the hanging openings to separate the calculator unit and the handwriting pad unit, thereby making it easier to carry the calculator unit or the handwriting pad unit for use. Moreover, according to the user’s writing habit, the user can connect the handwriting pad unit to the left side or the right side of the calculator unit, so as to accommodate the usage habits of both right-handed and left-handed users, while preventing accidental pressing of the calculator unit during use, thereby improving the user experience.

### BRIEF DESCRIPTION OF THE DRAWINGS

Implementations of the present disclosure will now be described, by way of embodiment, with reference to the attached figures. It should be understood, the drawings are shown for illustrative purpose only, for ordinary person skilled in the art, other drawings obtained from these drawings without paying creative labor by an ordinary person skilled in the art should be within scope of the present disclosure.

FIG. 1 is an unfolded state view showing that a handwriting pad unit is rotatably connected to a calculator unit of the present disclosure;

FIG. 2 is a folded state view showing that the handwriting pad unit is rotatably connected to the calculator unit of the present disclosure;

FIG. 3 is an exploded view showing that the handwriting pad unit is rotatably connected to the calculator unit of the present disclosure;

FIG. 4 is a schematic view of the handwriting pad unit when the handwriting pad unit is rotatably connected to the calculator unit of the present disclosure;

FIG. 5 is an enlarged view of area B in FIG. 4;

FIG. 6 is a schematic view of the calculator unit when the handwriting pad unit is rotatably connected to the calculator unit of the present disclosure;

FIG. 7 is an enlarged view of area C in FIG. 6;

FIG. 8 is an exploded view of the calculator unit when the handwriting pad unit is rotatably connected to the calculator unit of the present disclosure;

FIG. 9 is a partial internal structural view of the calculator unit when the handwriting pad unit is rotatably connected to the calculator unit of the present disclosure;

FIG. 10 is an enlarged view of area A in FIG. 9;

FIG. 11 is an assembled view of a first pulling member and a first circuit board when the handwriting pad unit is rotatably connected to the calculator unit of the present disclosure;

FIG. 12 is an exploded view of the handwriting pad unit when the handwriting pad unit is rotatably connected to the calculator unit of the present disclosure;

FIG. 13 is a folded state view of the handwriting pad unit and the calculator unit of the present disclosure connected by magnetic attraction;

FIG. 14 is an unfolded state view of the handwriting pad unit and the calculator unit of the present disclosure connected by magnetic attraction;

FIG. 15 is an exploded view of the calculator unit when the handwriting pad unit and the calculator unit of the present disclosure are in magnetic connection;

FIG. 16 is a structural view of a third front housing on the calculator unit when the handwriting pad unit and the calculator unit of the present disclosure are in magnetic connection;

FIG. 17 is an exploded view of the handwriting pad unit when the handwriting pad unit and the calculator unit of the present disclosure are in magnetic connection;

FIG. 18 is an assembled view of the third circuit board and the second pulling member when the handwriting pad unit and the calculator unit of the present disclosure are in magnetic connection;

FIG. 19 is a schematic view showing that the handwriting pad unit is located on the back of the calculator unit when the handwriting pad unit is slidably connected to the calculator unit of the present disclosure;

FIG. 20 is a schematic view showing that the handwriting pad unit is located on the front of the calculator unit when the handwriting pad unit is slidably connected to the calculator unit of the present disclosure;

FIG. 21 is an exploded view of the handwriting pad unit and the calculator unit when the handwriting pad unit is slidably connected to the calculator unit of the present disclosure;

FIG. 22 is an enlarged view of area D in FIG. 21;

FIG. 23 is an unfolded schematic view of the handwriting pad unit and the calculator unit connected by snap-fit connection according to the present disclosure;

FIG. 24 is an exploded view of the handwriting pad unit and the calculator unit when the handwriting pad unit and the calculator unit are connected by snap-fit connection;

FIG. 25 is a schematic view of a connecting block received in a fifth engaging groove when the handwriting pad unit and the calculator unit are connected by snap-fit connection;

FIG. 26 is a functional block diagram of a first battery, a power circuit, a boost module, and a first LCD screen of the present disclosure;

FIG. 27 is a circuit diagram of the power circuit of the present disclosure;

FIG. 28 is a circuit diagram of the boost module of the present disclosure;

FIG. 29 is a schematic view showing that the calculator unit and the handwriting pad unit are not overlapped;

FIG. 30 is an exploded view showing that the calculator unit and the handwriting pad unit are not overlapped;

FIG. 31 is a schematic view of a second device of the present disclosure received in a first receiving groove;

FIG. 32 is a schematic view of the second device of the present disclosure received in the first receiving groove from another angle;

FIG. 33 is an exploded view of the present disclosure;

FIG. 34 is a perspective view of the second device of the present disclosure;

FIG. 35 is a schematic view showing that hanging members of the present disclosure are arranged in hanging openings;

FIG. 36 is an enlarged view of area a in FIG. 33;

FIG. 37 is an enlarged view of area b in FIG. 33;

FIG. 38 is an enlarged view of area c in FIG. 33;

FIG. 39 is an enlarged view of area d in FIG. 35;

FIG. 40 is an exploded view of the second device of the present disclosure;

FIG. 41 is a schematic view showing that a back side of the calculator unit of the present disclosure is placed in the first receiving groove.

### DETAILED DESCRIPTION OF THE EMBODIMENTS

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein may be practiced without these specific details. In other instances, methods, procedures, and components have not been described in detail so as not to obscure the related relevant feature being described. Also, the description is not to be considered as limiting the scope of the exemplary embodiments described herein. The drawings are not necessarily to scale and the proportions of certain parts may be exaggerated to better illustrate details and features of the present disclosure.

The term “comprising” when utilized, means “including, but not necessarily limited to”; it specifically indicates open-ended inclusion or membership in the so-described combination, group, series, and the like. The disclosure is illustrated by way of example and not by way of limitation in the figures of the accompanying drawings in which like references indicate similar elements. It should be noted that references to “an” or “one” embodiment in this disclosure are not necessarily to the same embodiment, and such references can mean “at least one”. In addition, the terms “first” and “second” are used for descriptive purposes only and cannot be understood as indicating or implying relative importance or implying the number of indicated technical features. Thus, the features defined as “first” and “second” may explicitly or implicitly include one or more of the features. In the description of embodiments of the application, “a plurality of” means two or more, unless otherwise specifically defined.

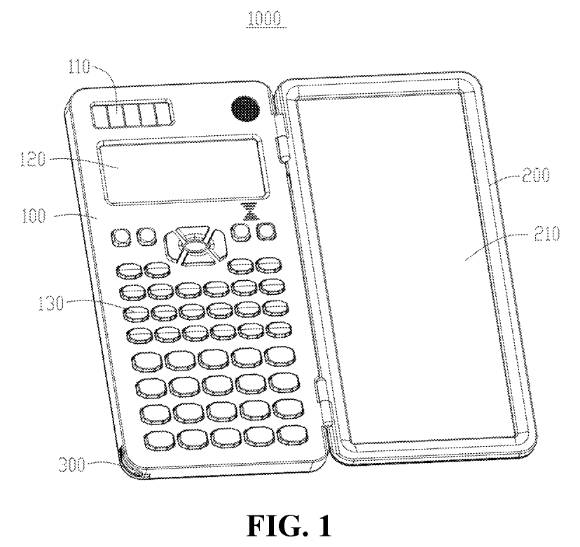

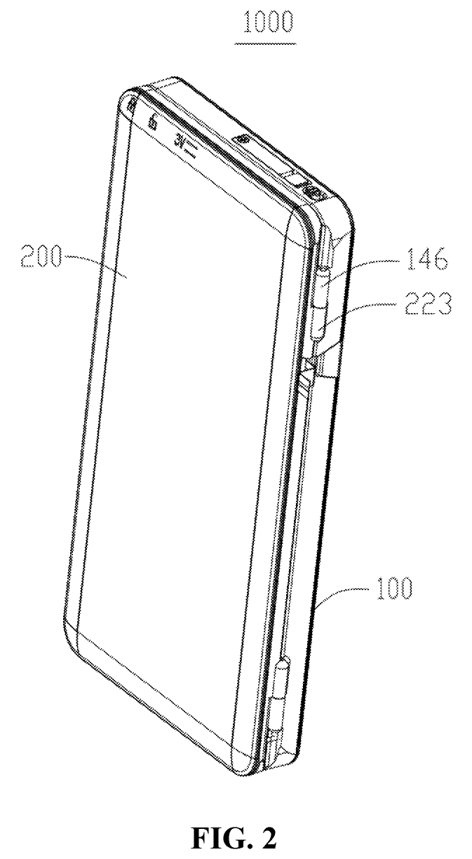

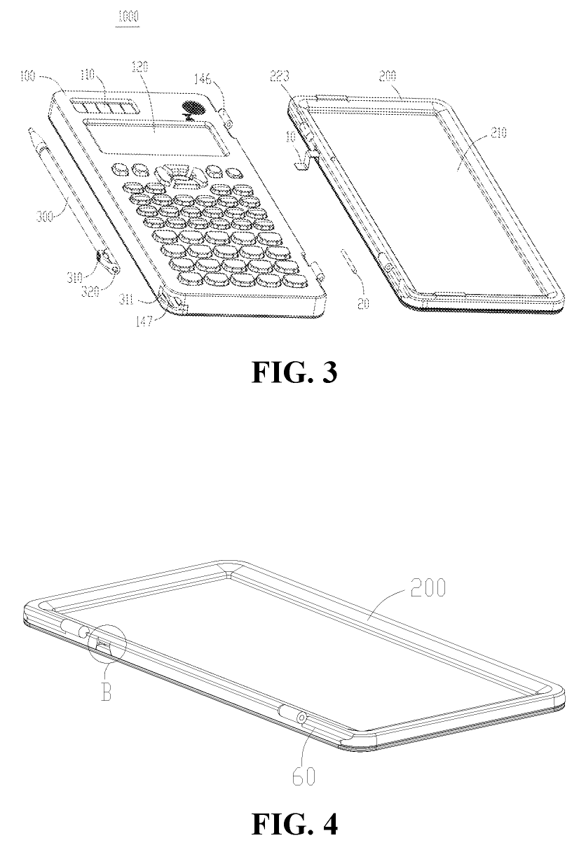

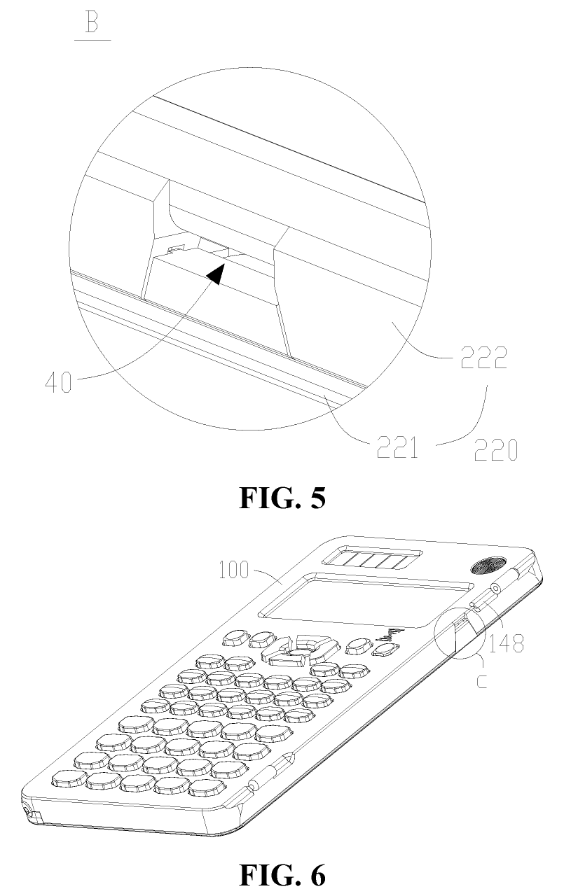

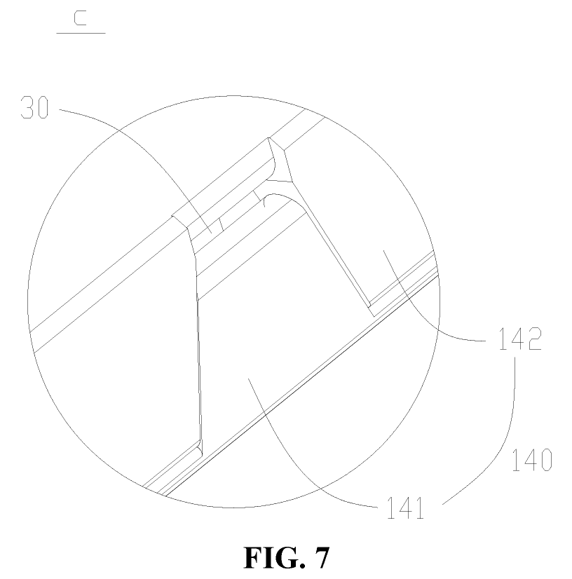

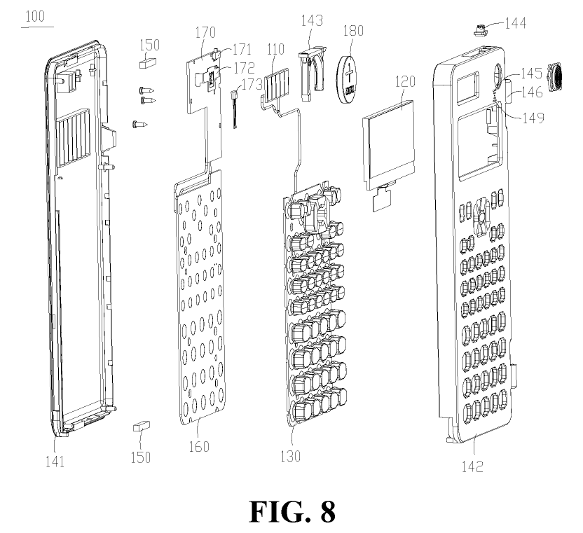

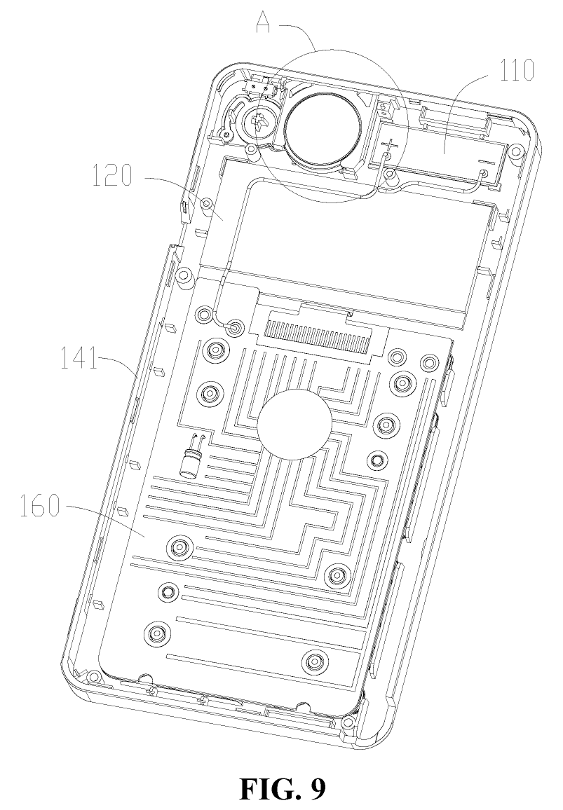

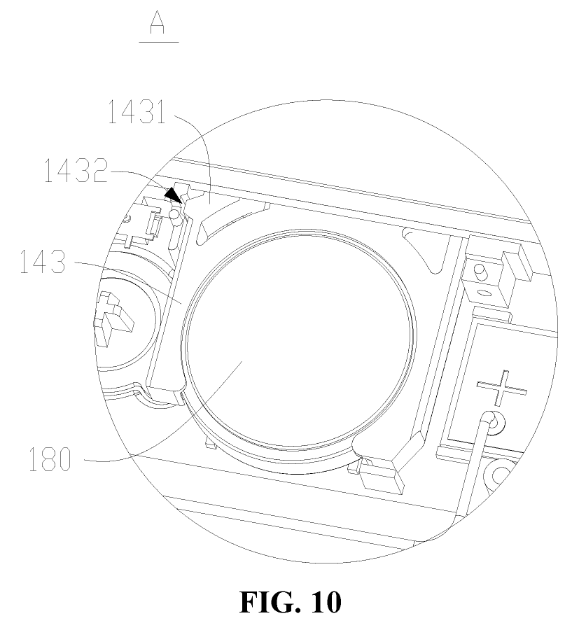

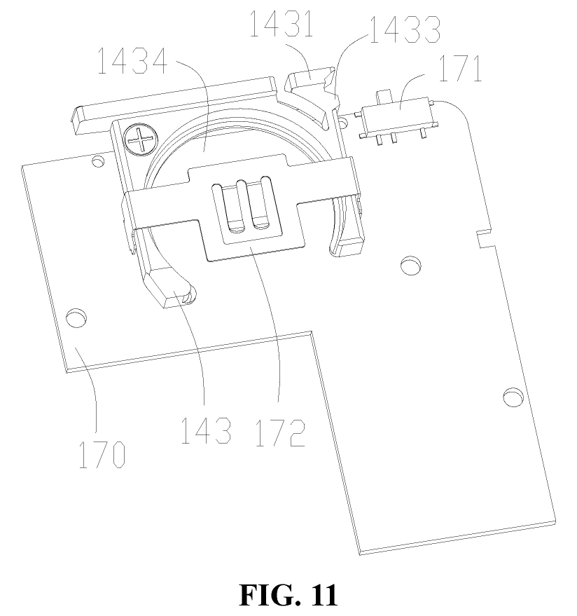

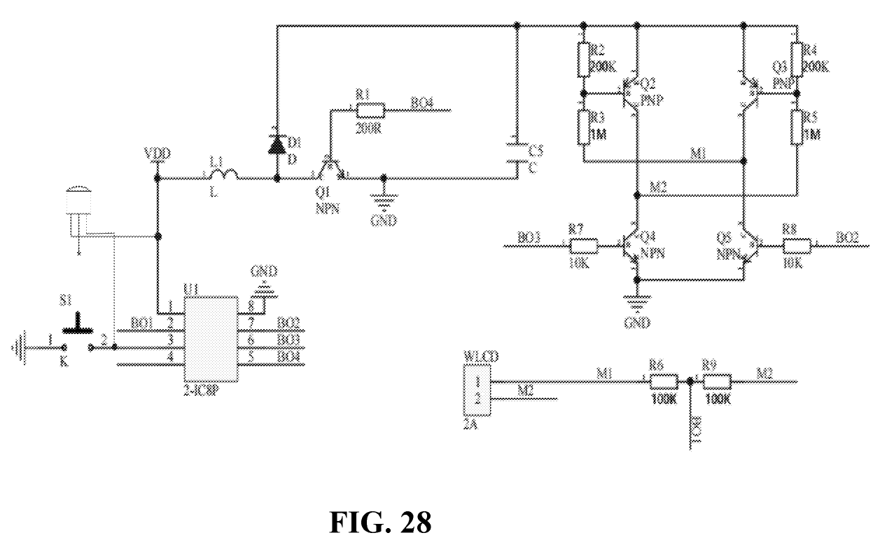

Referring to FIG. 1 - FIG. 28, the present embodiment of the present disclosure provides a calculator 1000 with a handwriting pad.

The calculator 1000 with a handwriting pad includes a handwriting pad unit 200, a calculator unit 100, and a stylus pen 300. The stylus pen 300 is detachably arranged on the calculator unit 100 or the handwriting pad unit 200, and the handwriting pad unit 200 is connected to the calculator unit 100. When in a stored state, the handwriting pad unit 200 and the calculator unit 100 are arranged in an overlapped manner from up to down. When in an unfolded state, a surface of the handwriting pad unit 200 is horizontally arranged side by side with the calculator unit 100.

In the present embodiment, the handwriting pad unit 200, the calculator unit 100, and the stylus pen 300 are connected together, so that the user can directly access them during use without having to search for them one by one. When not in use, the handwriting pad unit 200 and the calculator unit 100 can be placed in an overlapping manner, thereby reducing the overall volume for convenient carrying and storage. Moreover, the handwriting pad unit 200 and calculator unit 100 can be arranged horizontally side by side when in use, and in conjunction with the stylus pen 300, the user can record data or calculate on the handwriting pad unit 200 for subsequent calculation or verification using the calculator, making it convenient for the user to use.

In practical application, the handwriting pad unit 200 is rotatably connected to the calculator unit 100.

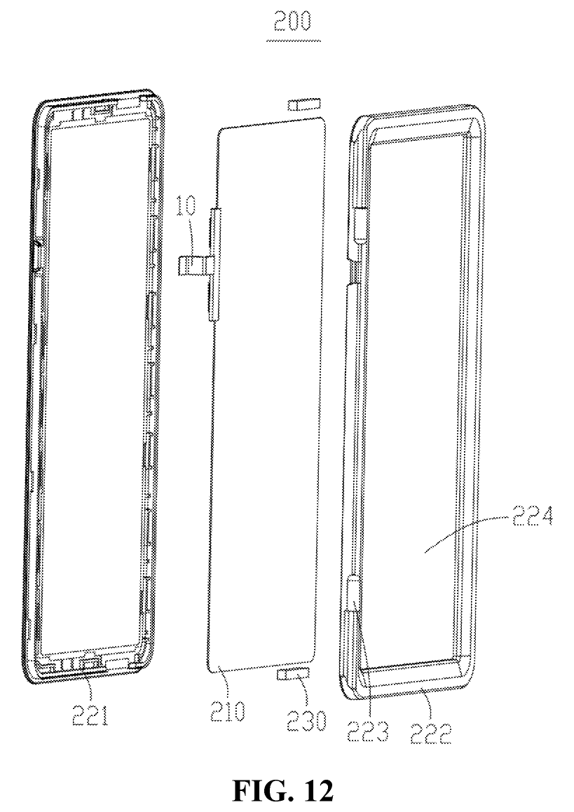

Referring to FIG. 1 - FIG. 12, specifically, at least one first rotating portion 223 is provided on the handwriting pad unit 200, and a second rotating portion 146 adapted for use with the first rotating portion 223 is provided on the calculator unit 100. The first rotating portion 223 is connected to the second rotating portion 146 via a shaft rod 20, so as to achieve rotational connection between the handwriting pad unit 200 and the calculator unit 100. Therefore, the handwriting pad unit 200 and the calculator unit 100 can be folded for placement when not in use, and can be unfolded when in use, so as to facilitate the use’s use. Of course, in other embodiments, the handwriting pad unit 200 and the calculator unit 100 can be connected via a hinge, which can also achieve the rotational connection between the handwriting pad unit 200 and the calculator unit 100.

In a preferred embodiment, at least one first magnetic attraction member 150 is provided within the calculator unit 100, and a second magnetic attraction member 230 adapted for use with the first magnetic attraction member 150 is provided on the handwriting pad unit 200. The first magnetic attraction member 150 and the second magnetic attraction member 230 are attracted to each other when the handwriting pad unit 200 and the calculator unit 100 are in the stored state, so as to achieve position fixation when the handwriting pad unit 200 and the calculator unit 100 are folded and placed. This can prevent the handwriting pad unit 200 and the calculator unit 100 from opening, and also facilitate storage and carrying. Moreover, other items can be prevented from colliding with a display unit on the handwriting pad unit 200 during the carrying process, thereby providing a protective function. One of the first magnetic attraction member 150 and the second magnetic attraction member 230 is a magnet, and the other is an iron block. Alternatively, both the first magnetic attraction member 150 and the second magnetic attraction member 230 are magnets.

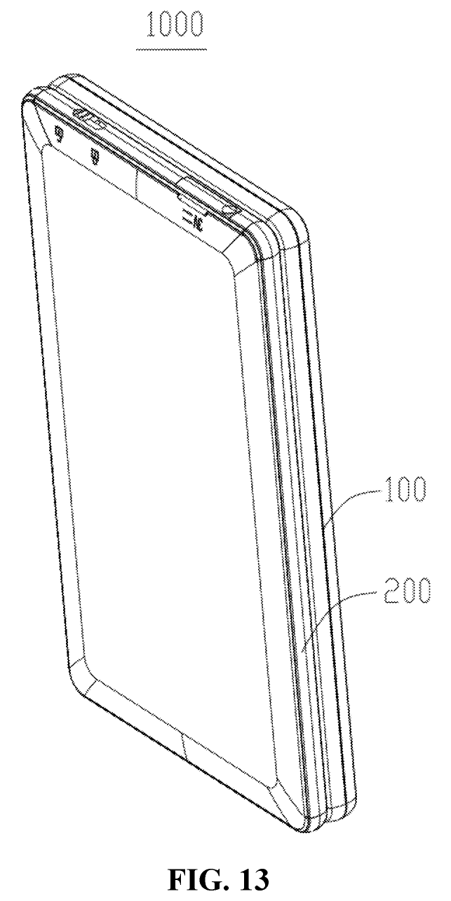

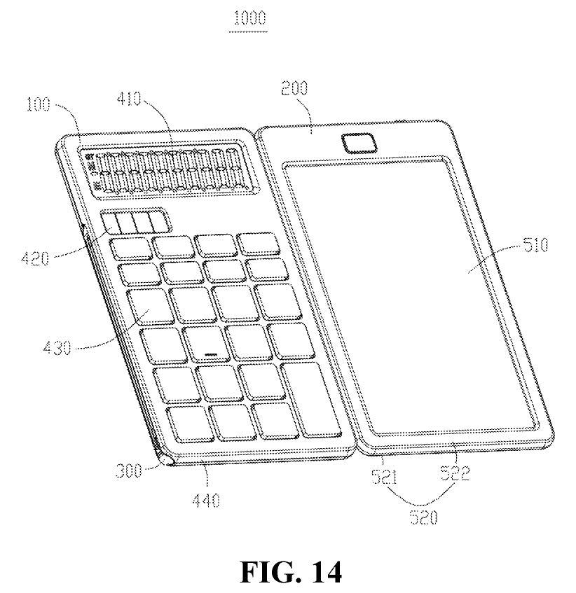

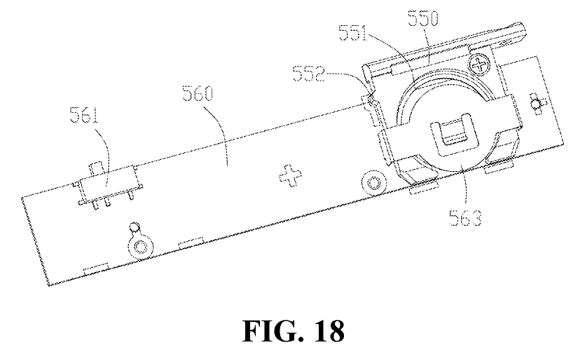

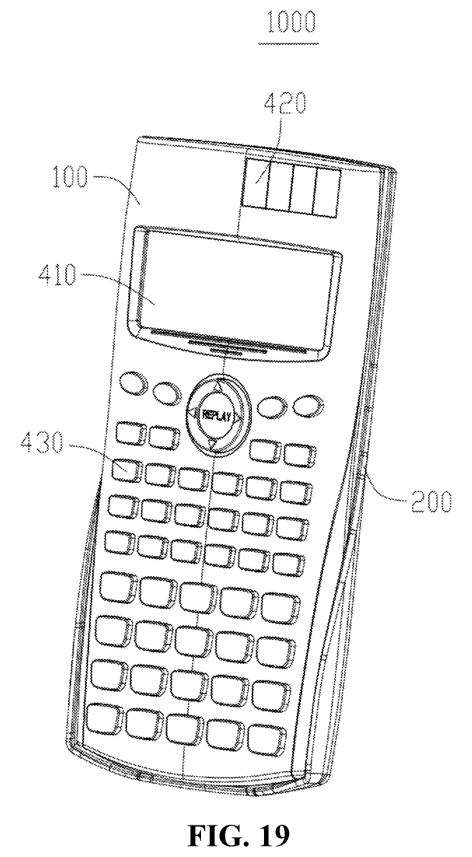

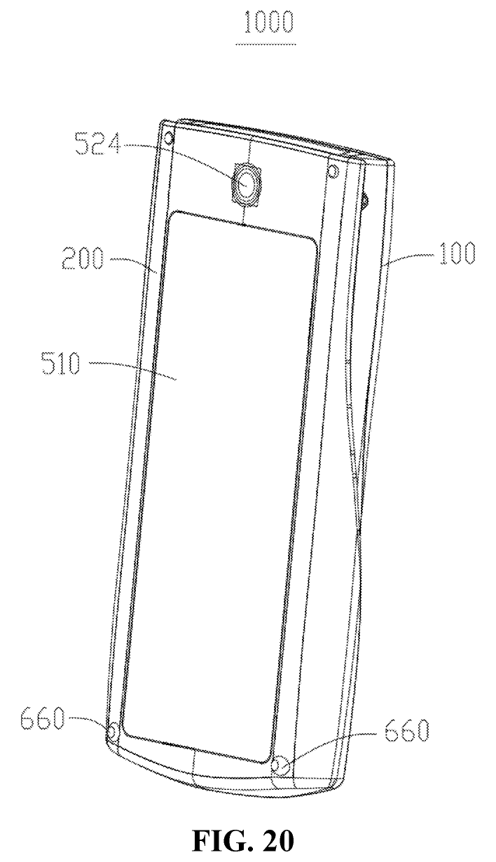

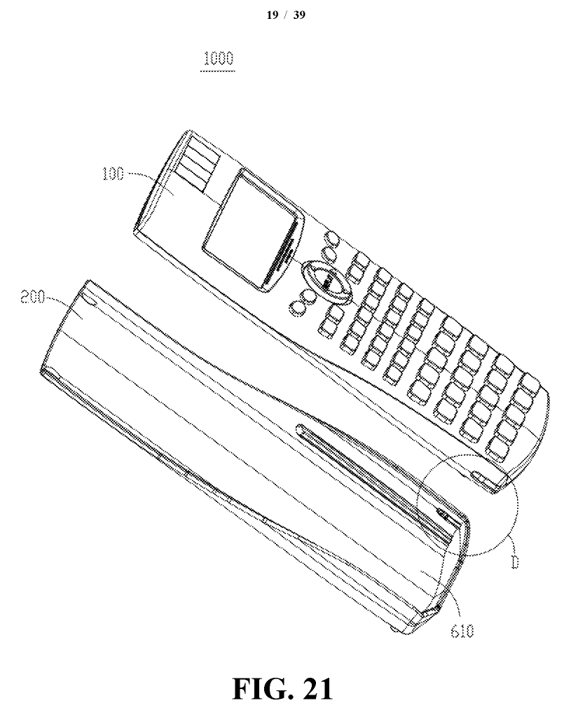

Referring to FIG. 13 - FIG. 18, in practical application, the handwriting pad unit 200 and the calculator unit 100 can also be connected by magnetic attraction, which also enables the handwriting pad unit 200 and the calculator unit 100 to be folded and placed when not in use, and be unfolded when in use.

Specifically, a plurality of third magnetic attraction members 530 are provided on the handwriting pad unit 200, and at least one portion of the plurality of third magnetic attraction members 530 are arranged near a peripheral side of the handwriting pad unit 200. The calculator unit 100 is provided with fourth magnetic attraction members 460 adapted to be attracted to the third magnetic attraction members 530. In this way, when the handwriting pad unit 200 and the calculator unit 100 are unfolded and horizontally arranged side by side, the third magnetic attraction members 530 and the fourth magnetic attraction members 460 are attracted and fixed to each other. When the handwriting pad unit 200 and the calculator unit 100 are stored and folded, the third magnetic attraction members 530 and the fourth magnetic attraction members 460 can be attracted to each other to fix a relative position between the handwriting pad unit 200 and the calculator unit 100, thereby preventing opening. The third magnetic attraction members 530 are magnets or iron blocks, and the fourth magnetic attraction members 460 are magnets. Alternatively, the third magnetic attraction members 530 are magnets, and the fourth magnetic attraction members 460 are iron blocks.

In a preferred embodiment, a total number of the third magnetic attraction members 530 and a total number of the fourth magnetic attraction members 460 are both four. The four third magnetic attraction members 530 are respectively arranged adjacent to four corners of the handwriting pad unit 200. Both the third magnetic attraction members 530 and the fourth magnetic attraction members 460 are long strip-shaped, so as to enhance the magnetic attraction force of the third magnetic attraction members 530 and the fourth magnetic attraction members 460.

In the present embodiment, three of the third magnetic attraction members 530 are arranged along a lengthwise direction of the calculator unit 100, and one of the third magnetic attraction members 530 is arranged along a width direction of the calculator unit 100. Of course, in other embodiments, all the four third magnetic attraction members 530 can be arranged along the lengthwise direction or the width direction of the calculator unit 100.

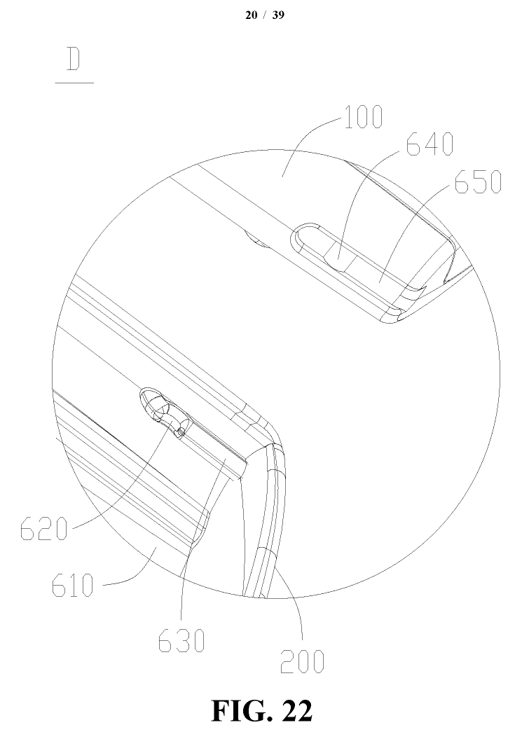

Referring to FIG. 19 - FIG. 22, in practical application, the handwriting pad unit 200 and the calculator unit 100 can also be slidably connected, which also enables the handwriting pad unit 200 and the calculator unit 100 to be folded and placed when not in use, and unfolded when in use.

Specifically, a sliding slot 610 is provided on a back surface of the handwriting pad unit 200 for accommodating the calculator unit 100. When in the stored state, the calculator unit 100 is arranged in the sliding slot 610, so as to achieve sliding connection between the calculator unit 100 and the handwriting pad unit 200. That is, the handwriting pad unit 200 can serve as a sliding cover. When the calculator unit 100 is in use, the sliding cover is placed on the back surface of the calculator unit 100. When the calculator unit 100 is not in use, the sliding cover serves as a protective cover and is arranged in front of the calculator unit 100, thereby protecting the calculator unit 100.

In a preferred embodiment, a limiting rib 630 is provided on a side wall of the sliding slot 610, and a second engaging groove 620 is provided on the limiting rib 630. A limiting groove 650, adapted for use with the limiting rib 630, is provided on a side wall of the calculator unit 100. The limiting groove 650 is located at a position adjacent to an end of the calculator unit 100. A second engaging block 640, adapted for use with the second engaging groove 620, is provided on the limiting groove 650. When in a stored state, the limiting rib 630 is received in the limiting groove 650, and the second engaging block 640 is received in the second engaging groove 620, thereby fixing the relative position between the calculator unit 100 and the handwriting pad unit 200. When the user needs to use both the handwriting pad unit 200 and the calculator unit 100, the calculator unit 100 can be pulled out to be separated from the handwriting pad unit 200, so that the handwriting pad unit 200 and the calculator unit 100 can be arranged horizontally side by side.

In a preferred embodiment, the handwriting pad unit 200 protrudes outward on one side away from the sliding slot 610 to form a supporting protruding block 660. Therefore, when the sliding cover is placed on the back surface of the calculator unit 100, the supporting protruding block 660 can support the entire product, so as to prevent a surface of the handwriting pad unit 200 from directly contacting a placement surface, thereby preventing the surface of the handwriting pad unit 200 from being scratched, which provides a protective function.

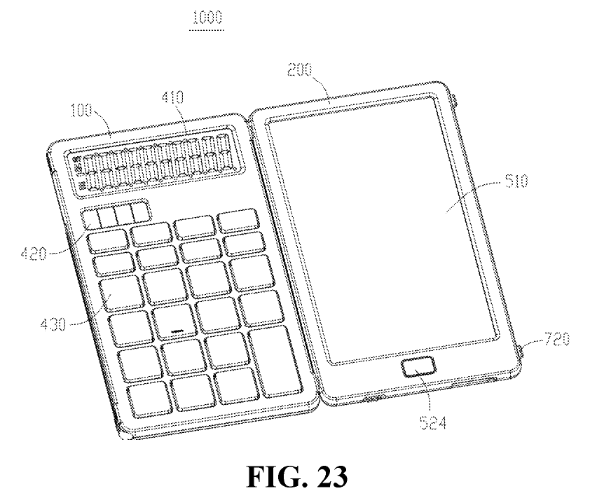

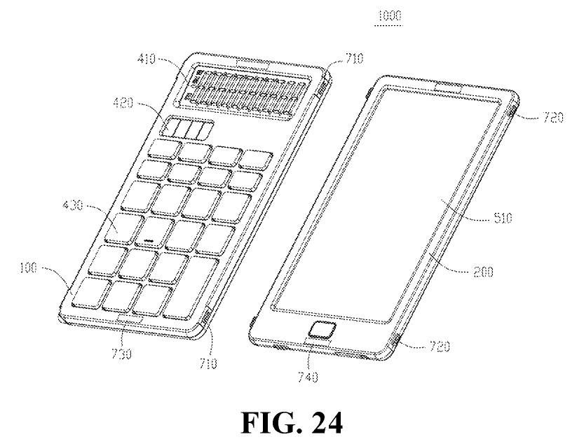

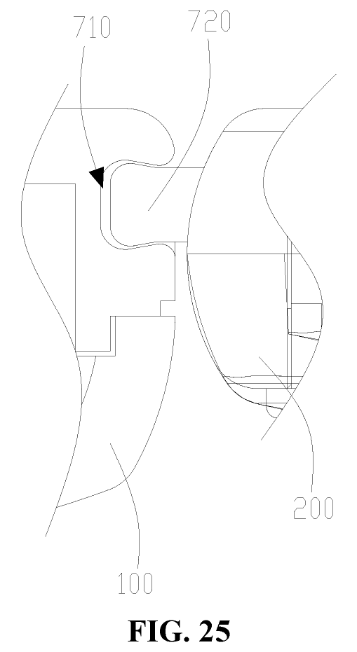

Referring to FIG. 23 - FIG. 25, in practical application, the handwriting pad unit 200 and the calculator unit 100 can also be connected by snap-fit connection, which can also enable the handwriting pad unit 200 and the calculator unit 100 to be folded and placed when not in use, and unfolded when in use.

Specifically, one side wall of the handwriting pad unit 200 is provided with connecting blocks 720, and one side wall of the calculator unit 100 is provided with fifth engaging grooves 710 adapted to use with the connecting blocks 720. The connecting blocks 720 are received in the fifth engaging groove 710 when the handwriting pad unit 200 is connected to the calculator unit 100. The handwriting pad unit 200 is provided with a fifth magnetic attraction member 740. The calculator unit 100 is provided with a sixth magnetic attraction member 730. The fifth magnetic attraction member 740 and the sixth magnetic attraction member 730 are attracted to each other when the handwriting pad unit 200 and the calculator unit 100 are stored.

That is, when the handwriting pad unit 200 and the calculator unit 100 are in use, the connecting block 720 is received in the fifth engaging groove 710 to connect the two units and arrange the two units horizontally side by side. When the handwriting pad unit 200 and the calculator unit 100 are stored, the fifth magnetic attraction member 740 and the sixth magnetic attraction member 730 are attracted to each other to secure the two units in a folded state.

One of the fifth magnetic attraction member 740 and the sixth magnetic attraction member 730 is a magnet, and the other is an iron block; or, both the fifth magnetic attraction member 740 and the sixth magnetic attraction member 730 are magnets. Of course, in other embodiments, the connecting block 720 may be arranged on a side wall of the calculator unit 100, and the fifth engaging groove 710 may be provided on the handwriting pad unit 200, and so on.

In one embodiment, a total number of the connecting blocks 720 is four. Two connecting blocks 720 are respectively arranged on two opposite side walls of the handwriting pad unit 200. Correspondingly, a total number of the fifth engaging grooves 710 is also four, and each fifth engaging groove 710 is provided at a position corresponding to a respective connecting block 720, so as to accommodate the writing habit of left-handed users.

In the above embodiments, that is, when the handwriting pad unit 200 and the calculator unit 100 are connected by methods of rotation, magnetic attraction, snap-fit, sliding, or the like, a power supply may be provided only in the calculator unit 100. Further, by electrically connecting the calculator unit 100 and the handwriting pad unit 200, power can be supplied to the handwriting pad unit 200. Alternatively, a power supply may be separately provided in each of the handwriting pad unit 200 and the calculator unit 100.

Referring to FIG. 1 - FIG. 12, in an embodiment where a power supply is provided in the calculator unit 100 and no power supply is provided in the handwriting pad unit 200, the calculator with a handwriting pad further includes a flexible connecting wire 10.

The calculator unit 100 is provided with a first circuit board 170 and a first clear switch 173 electrically connected to the first circuit board 170. The handwriting pad unit 200 is provided with a first liquid crystal display (LCD) screen 210. A first wire passage hole 30 is provided on a side of the calculator unit 100 adjacent to the handwriting pad unit 200, and a second wire passage hole 40 is provided on a side of the handwriting pad unit 200 adjacent to the calculator unit 100. The flexible connecting wire 10 passes through the first wire passage hole 30 and the second wire passage hole 40. A first end of the flexible connecting wire 10 is arranged in the calculator unit 100 and soldered to the first circuit board 170, and a second end of the flexible connecting wire 10 is arranged in the handwriting pad unit 200 and soldered to the first LCD screen 210, so that the handwriting pad unit 200 is electrically connected to the calculator unit 100. When the first clear switch 173 is operated, it feeds back an electrical signal to the first circuit board 170, and the first circuit board 170 clears the content displayed on the first LCD screen 210 via the flexible connecting wire 10.

The calculator unit 100 is provided with a first battery 180, a second circuit board 160, a first display 120, and a first key module 130. The first circuit board 170 and the first display 120 are both electrically connected to the second circuit board 160, and the first battery 180 is electrically connected to the first circuit board 170, so as to supply power to the first circuit board 170. The power is also supplied to the second circuit board 160 via the first circuit board 170, and the power is also supplied to the first LCD screen 210 via the first circuit board 170 and the flexible connecting wire 10. The first battery 180, the first circuit board 170, and the first display 120 are all positioned above the second circuit board 160, so that the layout is reasonable, and a volume of the calculator unit 100 can be effectively reduced. The second circuit board 160 performs calculation on the input data when the first key module 130 is operated, so as to achieve a function of the calculator unit 100 and facilitate the user’s operation and calculation.

In one embodiment, the calculator unit 100 is further provided with a first locking switch 171 electrically connected to the first circuit board 170. When the first circuit board 170 receives an electrical signal fed back by the first locking switch 171, the first circuit board 170 locks the content displayed on the first LCD screen 210 via the flexible connecting wire 10, so as to prevent the user from clearing the content on the first LCD screen 210 when accidentally operating the first clear switch 173.

In one embodiment, a side wall of the first wire passage hole 30 and/or a side wall of the second wire passage hole 40 along a lengthwise direction are/is smooth curved surface(s). Therefore, when the handwriting pad unit 200 and the calculator unit 100 are rotated, friction and creases on the flexible connecting wire 10 can be effectively reduced, and a service life of the flexible connecting wire 10 can be extended.

In one embodiment, a total sum of a distance between a bottom surface of the first circuit board 170 and the first wire passage hole 30, a width of the first wire passage hole 30, a distance between the first wire passage hole 30 and the second wire passage hole 40, a width of the second wire passage hole 40, and a distance between the second wire passage hole 40 and the first LCD screen 210 is defined as a first length. After portions soldered to the first circuit board 170 and the first LCD screen 210 are deducted from the flexible connecting wire 10, a remaining length of the flexible connecting wire 10 is greater than the first length. Therefore, when the handwriting pad unit 200 rotates relative to the calculator unit 100, the flexible connecting wire 10 is not folded along a single line but rather over an area, thereby further extending the service life of the flexible connecting wire 10. Specifically, after the portions soldered to the first circuit board 170 and the first LCD screen 210 are deducted from the flexible connecting wire 10, the remaining length of the flexible connecting wire 10 is greater than the first length by 1 mm.

In one embodiment, the first clear switch 173 is a Hall switch. An end of the stylus pen 300 is provided with a magnetic field magnet 320 for generating a magnetic field. When the first circuit board 170 receives an electrical signal fed back by the Hall switch, the content displayed on the first LCD screen 210 is cleared via the flexible connecting wire 10. Therefore, when the user needs to clear the content on the first LCD screen 210, the end of the stylus pen 300 can be placed close to the Hall switch.

In one embodiment, the calculator unit 100 is provided with a first photovoltaic panel 110. The first photovoltaic panel 110 is electrically connected to the second circuit board 160. The first battery 180 is a rechargeable battery. The first photovoltaic panel 110 is configured for converting light energy into electrical energy and transmitting the electrical energy to the second circuit board 160. The second circuit board 160 is configured for processing the electrical energy transmitted by the first photovoltaic panel 110 and then storing the electrical energy into the first battery 180 via the first circuit board 170, thereby saving resources.

Specifically, the first photovoltaic panel 110 may be arranged between the first display 120 and the first key module 130, or the first photovoltaic panel 110 may also be positioned on one side of the first display 120 away from the first key module 130.

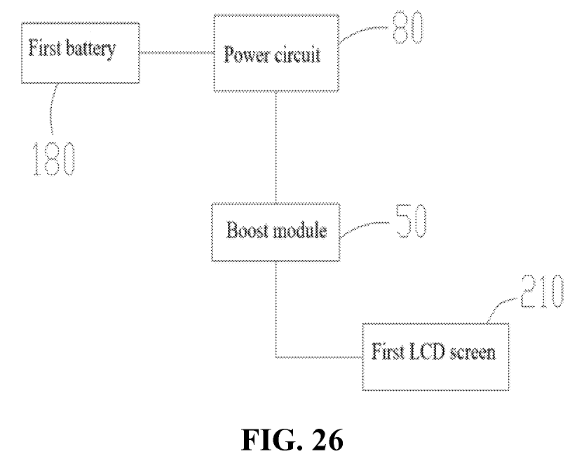

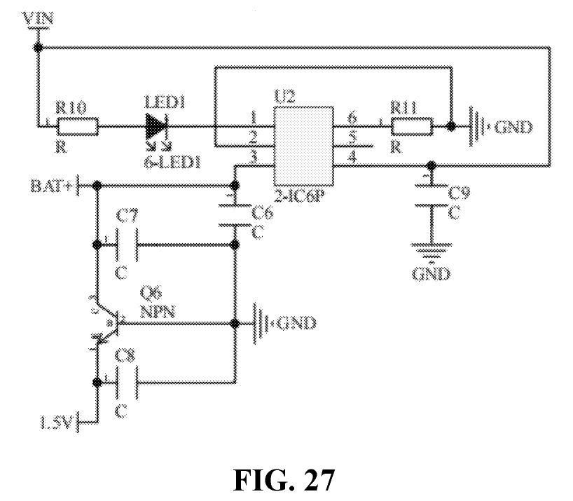

Referring to FIG. 26 - FIG. 28, in one embodiment, a power circuit 80 and a boost module 50 are integrated on the first circuit board 170. The power circuit 80 is electrically connected to the second circuit board 160, the first battery 180, and the boost module 50, respectively. The power circuit 80 can be connected to an external power source to charge the first battery 180. The power circuit 80 can also be used to manage the charging and discharging of the first battery 180. In addition, the power circuit 80 can be electrically connected to the first photovoltaic panel 110, so as to process the electrical energy converted from light energy by the first photovoltaic panel 110, and then to store the processed electrical energy in the first battery 180. The boost module 50 is electrically connected to the first clear switch 173 and the first LCD screen 210, respectively. Thus, when the boost module 50 detects an electrical signal fed back by the first clear switch 173, the boost module 50 boosts the voltage output by the power circuit 80 and transmits the boosted voltage to the first LCD screen 210, thereby clearing the content displayed on the first LCD screen 210.

Specifically, the boost module 50 includes a boost chip U1, a first inductor L1, a first diode D1, a first transistor Q1, a first resistor R1, a first capacitor C5, a second resistor R2, a third resistor R3, a second transistor Q2, a fourth resistor R4, a fifth resistor R5, a sixth resistor R6, a ninth resistor R9, a third transistor Q3, a fourth transistor Q4, a seventh resistor R7, a fifth transistor Q5, an eighth resistor R8, and a connection interface WLCD.

A model of the boost chip U1 can be SAP02. A first pin of the boost chip U1 is connected to a collector electrode of the first transistor Q1 via the first inductor L1. The collector electrode of the first transistor Q1 is connected to the first capacitor C5, the second resistor R2, a first pin of the second transistor Q2, a third pin of the third transistor Q3, and the fourth resistor R4 respectively after passing through the first diode D1. A second pin of the boost chip U1 is connected at a connection between the sixth resistor R6 and the ninth resistor R9. A fifth pin of the boost chip U1 is connected to a base electrode of the first transistor Q1 via the first resistor R1. A sixth pin of the boost chip U1 is connected to a base electrode of the fourth transistor Q4 via the seventh resistor R7. A seventh pin of the boost chip U1 is connected to a base electrode of the fifth transistor Q5 via the eighth resistor R8. An emitter electrode of the first transistor Q1 and one end of the first capacitor C5 are grounded. Two ends of the second resistor R2 are respectively connected to a base electrode of the second transistor Q2 and a collector electrode of the second transistor Q2. Two ends of the third resistor R3 are respectively connected to the base electrode of the second transistor Q2 and a collector electrode of the third transistor Q3. Two ends of the fourth resistor R4 are respectively connected to a base electrode of the third transistor Q3 and an emitter electrode of the third transistor Q3. Two ends of the fifth resistor R5 are respectively connected to the base electrode of the third transistor Q3 and a collector electrode of the fourth transistor Q4. The collector electrode of the second transistor Q2 is electrically connected to the collector electrode of the fourth transistor Q4. An emitter electrode of the fourth transistor Q4 and an emitter electrode of the fifth transistor Q5 are both grounded. The first transistor Q1, the fourth transistor Q4, and the fifth transistor Q5 are all NPN-type transistors. The second transistor Q2 and the third transistor Q3 are PNP-type transistors.

When the first clear switch 173 is a Hall switch, the first pin of the boost chip U1 is further connected to the power circuit 80 and a first pin of the Hall switch, and a third pin of the Hall switch is connected to a third pin of the boost chip U1. When the first clear switch 173 is a button switch, one end of the button switch is connected to the third pin of the boost chip U1, and an opposite end of the button switch is grounded.

The connection interface WLCD is connected to the first LCD screen 210. A first pin of the connection interface WLCD is connected to the collector electrode of the third transistor Q3 sequentially via the sixth resistor R6 and the ninth resistor R9. A second pin of the connection interface WLCD is connected to the collector electrode of the fourth transistor Q4.

When the button switch is turned on, a voltage on the third pin of the boost chip U1 is reduced. Alternatively, when the boost chip U1 detects a voltage fed back by the Hall switch, the boost chip U1 outputs a voltage of a certain frequency to the first transistor Q1 via the first resistor R1, and a return circuit (loop) of the first inductor L1 is utilized to achieve voltage boosting. Then, through a return circuit (loop) of the second transistor Q2 and the fourth transistor Q4, the boosted voltage is output to the first LCD screen 210 via the connection interface WLCD, so as to clear the content on the first LCD screen 210.

Referring to FIG. 1 - FIG. 12, in one embodiment, the first battery 180 is a button battery, and an arch-shaped first conductive sheet 172 is provided on the first circuit board 170. The calculator unit 100 is detachably provided with a first pulling member 143, and a first placement groove 1434 is defined in the first pulling member 143. The first battery 180 is positioned in the first placement groove 1434. When the first pulling member 143 is partially arranged in the calculator unit 100, one surface of the first battery 180 abuts against a solder pad on the first circuit board 170, and an opposite surface of the first battery 180 abuts against the first conductive sheet 172. Therefore, when the first battery 180 runs out of battery, the user can remove the first pulling member 143 from the calculator unit 100 to replace the first battery 180, and then install the first pulling member 143, so as to improve a service life of the product in the present embodiment.

Specifically, the first pulling member 143 is fixed to the calculator unit 100 by a screw at one end of the first placement groove 1434. The first pulling member 143 is provided with a first elastic member 1431 at an opposite end of the first placement groove 1434. A first engaging block 1433 is provided on the first elastic member 1431. The calculator unit 100 is provided with a first engaging groove 1432 at a position corresponding to the first engaging block 1433. The first engaging block 1433 is received in the first engaging groove 1432 when the first pulling member 143 is mounted on the calculator unit 100. That is, one side of the first pulling member 143 is fixed to the calculator unit 100 by snap-fit connection, and an opposite side of the first pulling member 143 is fixed with a screw, so as to stably fix the first pulling member 143 on the calculator unit 100. When the first pulling member 143 needs to be disassembled, the screw can be unscrewed, and then the first pulling member 143 is pulled with force, so that the first pulling member 143 is removed from the calculator unit 100.

In one embodiment, in order to facilitate the disassembly and assembly of the first pulling member 143, a side surface of the first engaging block 1433 and a side surface of the first engaging groove 1432 are inclined surfaces, so that the first engaging block 1433 can be arranged in the first engaging groove 1432, and the first engaging block 1433 can also be easily detached from the first engaging groove 1432.

In the above embodiments, the calculator unit 100 includes a third outer housing 140. The third outer housing 140 includes a third front housing 142 and a third bottom housing 141. The third front housing 142 and the third bottom housing 141 can be connected by snap-fit connection, screws, or the like. The third front housing 142 is connected to the third bottom housing 141 to form the first wire passage hole 30. The second rotating portion 146 and the third front housing 142 are integrally formed by injection molding. The first key module 130 is arranged on the third front housing 142. The first locking switch 171 is arranged on the first circuit board 170. The first clear switch 173 is arranged on the second circuit board 160. By electrically connecting the second circuit board 160 to the first circuit board 170, the first clear switch 173 is electrically connected to the first circuit board 170. The first circuit board 170 is positioned behind the first display 120. The first display 120 is arranged on the third front housing 142. The first pulling member 143 is locked on the third front housing 142 via screws. The first battery 180 is positioned on one side of the first circuit board 170 adjacent to the third front housing 142. The first circuit board 170 is provided with a first switch button. By operating the first key module 130, the calculator unit 100 can be turned on for numerical calculation. The third front housing 142 is provided with a through hole 149 at a position corresponding to the Hall switch, so that the Hall switch can detect the magnetic field generated by the magnetic field magnet 320.

The handwriting pad unit 200 includes a fourth outer housing 220. The fourth outer housing 220 includes a fourth front housing 222 and a fourth bottom housing 221. The fourth front housing 222 can be connected to the fourth bottom housing 221 by snap-fit connection, screws, and the like. The fourth front housing 222 is connected to the fourth bottom housing 221 to form the second wire passage hole 40. The first rotating portion 223 and the fourth front housing 222 are integrally formed by injection molding.

The third front housing 142 is recessed at a position corresponding to the first rotating portion 223 to form a first clearance slot 148, and the fourth front housing 222 is recessed at a position corresponding to the second rotating portion 146 to form a second clearance slot 60. When the first rotating portion 223 is connected to the second rotating portion 146, the second rotating portion 146 is at least partially received in the second clearance slot 60, and the first rotating portion 223 is at least partially received in the first clearance slot 148, thereby reducing a thickness of the calculator unit 100 and the handwriting pad unit 200 when in the stored state.

In the above embodiments, the first battery 180 is only arranged inside the calculator unit 100, and the flexible connecting wire 10 is used for controlling the handwriting pad unit 200 and supplying power to the handwriting pad unit 200. Moreover, the handwriting pad unit 200 is not provided with a battery, a circuit board, a clear switch, and a locking switch, which can maximize a volume of the first LCD screen 210 and increase a handwriting area, thereby improving the user experience of the handwriting pad unit 200.

In one embodiment, the fourth front housing 222 is provided with a second display opening 224 at a position corresponding to the first LCD screen 210, so that the user can write on the first LCD screen 210. A height of a side wall of the second display opening 224 is equal to or greater than a height by which the first key module 130 protrudes from an outer side of the third front housing 142. Therefore, when the calculator unit 100 and the handwriting pad unit 200 are folded and stored, the first key module 130 protruding from the outer side of the third front housing 142 is positioned on the side wall formed by the second display opening 224, so that the first magnetic attraction member 150 and the second magnetic attraction member 230 are attracted to each other, and the calculator unit 100 abuts against a surface of the handwriting pad unit 200.

In one embodiment, a storage slot 147 is defined in the third outer housing 140 for storing the stylus pen 300. When the stylus pen 300 is received in the storage slot 147, the stylus pen 300 is fixed by a snap-fit structure. Specifically, a top portion of the stylus pen 300 is provided with a friction protrusion 310. A window 311 is defined in the third outer housing 140 at a position corresponding to the friction protrusion 310. The user can remove the stylus pen 300 from the storage slot 147 by moving the friction protrusion 310, making it convenient for the user to use.

When the handwriting pad unit 200 is connected to the calculator unit 100 by magnetic attraction, the fourth front housing 222 is connected to the fourth bottom housing 221 to form a first mounting slot 70. The third magnetic attraction members 530 are arranged inside the first mounting slot 70, so that the third magnetic attraction members 530 are fixed. The third front housing 142 is connected to the third bottom housing 141 to form a second mounting slot 443. The fourth magnetic attraction members 460 are arranged inside the second mounting slot 443, so that the fourth magnetic attraction members 460 are fixed. In other embodiments, the third magnetic attraction members 530 may also be molded integrally with the fourth front housing 222 or the fourth bottom housing 221 during injection molding. The fourth magnetic attraction members 460 may also be molded integrally with the third front housing 142 or the third bottom housing 141 during injection molding. Alternatively, the third magnetic attraction members 530 can be fixed to the fourth outer housing 220 by snap-fit connection, adhesive bonding, or the like. The fourth magnetic attraction members 460 can also be fixed to the third outer housing 140 by snap-fit connection, adhesive bonding, or the like.

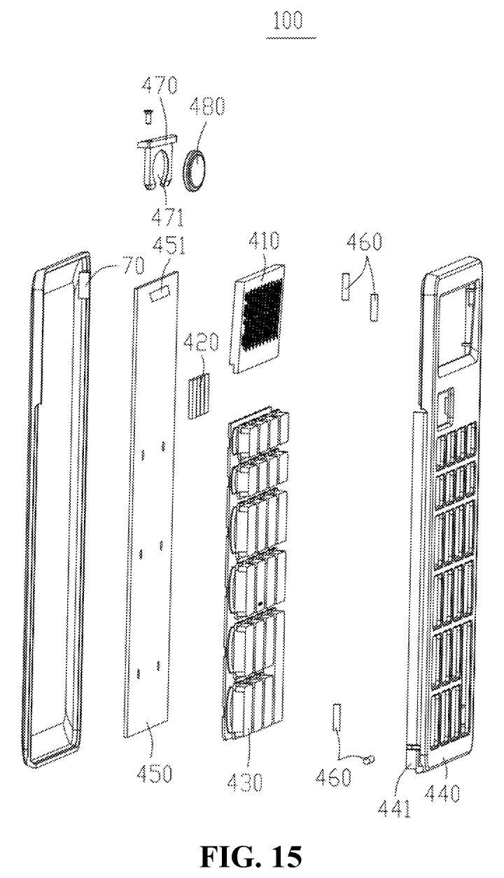

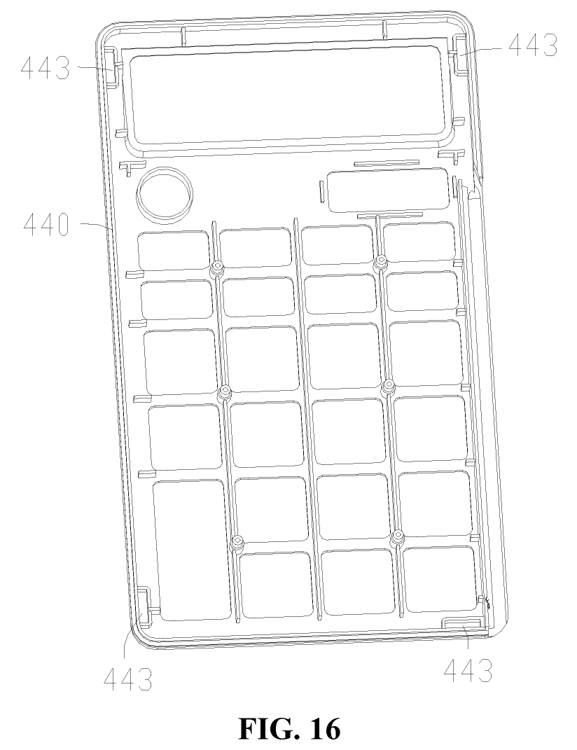

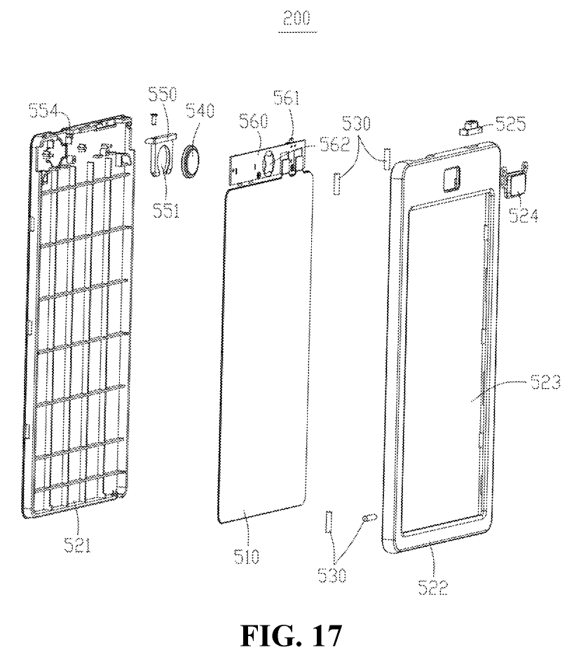

Referring to FIG. 15 - FIG. 18, when the handwriting pad unit 200 and calculator unit 100 are both internally provided with a separate power supply, the handwriting pad unit 200 includes a first outer housing 520, a second battery 540, a third circuit board 560, and a second liquid crystal display (LCD) screen 510. The third circuit board 560, the second battery 540, and the second LCD screen 510 are all arranged inside the first outer housing 520. The second LCD screen 510 and the second battery 540 are both electrically connected to the third circuit board 560. The third circuit board 560 is positioned above or below the second LCD screen 510. A first display opening 523 is defined in a surface of the first outer housing 520 at a position corresponding to the second LCD screen 510. The second battery 540 can supply power to the third circuit board 560 and the second LCD screen 510. The third circuit board 560 is provided with a second clear switch 562. The first outer housing 520 is provided with a first pressing member 524 at a position corresponding to the second clear switch 562. The first pressing member 524 is connected to the second clear switch 562. When the third circuit board 560 detects an electrical signal fed back by the second clear switch 562, the third circuit board 560 controls the second LCD screen 510 to clear the displayed content. Therefore, the first pressing member 524 can be operated and pressed to clear the content on the second LCD screen 510 as needed.

In one embodiment, a second locking switch 561 is provided on the third circuit board 560. A first operating member 525 is arranged on the first outer housing 520 at a position corresponding to the second locking switch 561. The first operating member 525 is connected to the second locking switch 561. When the third circuit board 560 detects an electrical signal fed back by the second locking switch 561, the content displayed on the second LCD screen 510 is locked. Therefore, when the user needs to lock the content displayed on the second LCD screen 510 to prevent it from being accidentally cleared, the user can press the first operating member 525.

Specifically, the second locking switch 561 is a Dual In-line Package (DIP) switch. The first pressing element 524 is positioned on a surface of the first outer housing 520 provided with the first display opening 523, and the second locking switch 561 is positioned at a top portion of the first outer housing 520.

In one embodiment, the top portion of the first outer housing 520 is detachably provided with a second pulling member 550. A second placement groove 551 is defined in the second pulling member 550. A second conductive sheet 563 in an arched shape is provided on the third circuit board 560. The second battery 540 is a button battery, and the second battery 540 is mounted on the second placement groove 551. When the second pulling member 550 is assembled onto the first outer housing 520, the second placement groove 551 is received in the first outer housing 520 and below the second conductive sheet 563. One surface of the second battery 540 abuts against the second conductive sheet 563, and an opposite surface of the second battery 540 abuts against a solder pad on the third circuit board 560. When the second battery 540 is out of power, the user can remove the second pulling member 550 from the first outer housing 520 to replace the second battery 540, and then install the second pulling member 550, so as to extend the service life of the product in the present embodiment.

Specifically, one end of the second pulling member 550 is fixed to the first outer housing 520 by screws. The second pulling member 550 is provided with a third engaging block 552 on a side wall corresponding to the second placement groove 551. The first outer housing 520 is provided with a third engaging groove 554 at a position corresponding to the third engaging block 552. The third engaging block 552 is received in the third engaging groove 554 when the second pulling member 550 is mounted on the first outer housing 520. That is, one side of the second pulling member 550 is fixed to the first outer housing 520 by snap-fit connection, and an opposite side of the second pulling member 550 is fixed by screws, so as to stably fix the second pulling member 550 on the first outer housing 520. When the second pulling member 550 needs to be removed, the screws can be unscrewed, and then the second pulling member 550 is forcefully pulled, so as to remove the second pulling member 550 from the first outer housing 520.

In one embodiment, in order to facilitate the disassembly and assembly of the second pulling member 550, a side surface of the third engaging block 552 and a side surface of the third engaging groove 554 are inclined surfaces, so that the third engaging block 552 can be arranged inside the third engaging groove 554, and the third engaging block 552 can also be easily detached from the third engaging groove 554.

The calculator unit 100 includes a second outer housing 440, a second display 410, a fourth circuit board 450, a second key module 430, and a third battery 480. The fourth circuit board 450, the third battery 480, and the second display 410 are all positioned inside the second outer housing 440. The second key module 430 is positioned on the second outer housing 440 and corresponds to the fourth circuit board 450. The third battery 480 and the second display 410 are both electrically connected to the fourth circuit board 450. The third battery 480 and the second display 410 are both positioned above the fourth circuit board 450. The fourth circuit board 450 calculates the input data when the second key module 430 is operated. The third battery 480 can supply power to the fourth circuit board 450, and the calculator unit 100 can be turned on by operating the second key module 430, so as to perform numerical calculation.

In one embodiment, the calculator unit 100 is provided with a second photovoltaic panel 420. The second photovoltaic panel 420 is electrically connected to the fourth circuit board 450. The third battery 480 is a rechargeable battery. The second photovoltaic panel 420 is configured for converting light energy into electrical energy and transmitting the electrical energy to the fourth circuit board 450. The fourth circuit board 450 is configured for processing the electrical energy transmitted by the second photovoltaic panel 420, and then the electrical energy is stored into the third battery 480 via the fourth circuit board 450, so as to extend the service life of the third battery 480 and save resources.

In one embodiment, a top portion of the second outer housing 440 is detachably provided with a third pulling member 470 at a position corresponding to the third battery 480. The third pulling member 470 is provided with a third placement groove 471. The fourth circuit board 450 is provided with an arch-shaped third conductive sheet 451. The third battery 480 is a button battery. The third battery 480 is mounted on the third placement groove 471. When the third pulling member 470 is assembled onto the second outer housing 440, the third placement groove 471 is arranged inside the second outer housing 440 and below the third conductive sheet 451. One surface of the third battery 480 abuts against the third conductive sheet 451, and an opposite surface of the third battery 480 abuts against a solder pad on the fourth circuit board 450. When the third battery 480 is out of power, the user can remove the third pulling member 470 from the second outer housing 440 to replace the third battery 480, and then install the third pulling member 470, so as to extend the service life of the product in the present embodiment.

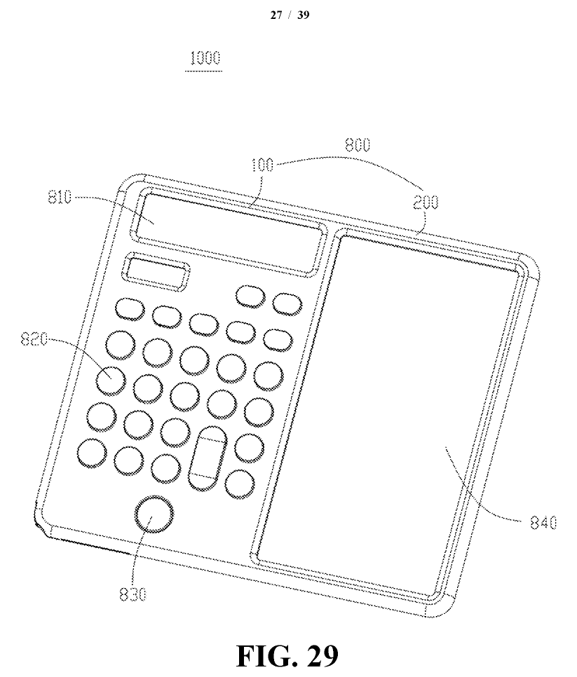

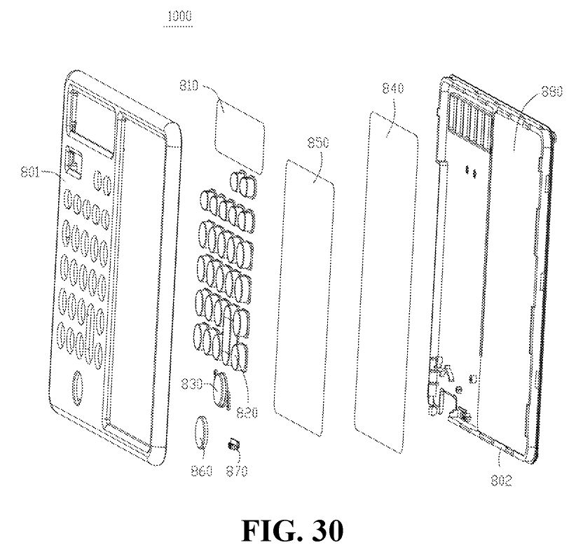

Referring to FIG. 29 and FIG. 30, in other embodiments, the calculator unit 100 and the handwriting pad unit 200 may be arranged in an overlapping manner from up to down when not stored. That is, the calculator unit 100 and the handwriting pad unit 200 are integrated into one unit and are in a straight plate configuration.

When the calculator unit 100 and the handwriting pad unit 200 are integrated, the calculator with a handwriting pad includes a main body 800. A stylus pen 300 is detachably arranged on the main body 800. A control module 850 is arranged on the main body 800. The control module 850 is equivalent to the first circuit board 170. A third key module 820 for operation by a user, a third display 810 electrically connected to the control module 850, a third LCD screen 840, and a third clear switch 830 are arranged on the main body 800. The control module 850 performs a mathematical operation when the user operates the third key module 820, and an operation result is displayed by the third display 810. The third LCD screen 840 is configured for use with the stylus pen 300 for writing, and the third clear switch 830 is configured to be operated by the user and generate a clear signal. The control module 850 is configured for receiving a clear signal and clearing the content displayed on the third LCD screen 840, according to the clear signal.

In the present embodiment, a function of the handwriting pad can be achieved by adaptive use of the third LCD screen 840 and the stylus pen 300, so that the user can record data by using the third LCD screen 840. Through the arrangement of the third key module 820 and the control module 850 on the main body 800, when the user operates the third key module 820, the control module 850 can perform mathematical operations based on numbers and operation symbols corresponding to the third key module 820 to achieve a function of the calculator. When the stylus pen 300 is detachably connected to the main body 800, when the user needs to write, the stylus pend 300 can be directly got. When the stylus pen 300 is not in use, the stylus pen 300 can be fixed to the main body 800 to prevent the stylus pen 300 from being lost, making it convenient for the user to carry and store the stylus pen. Through the above structure, by integrating the function of the calculator with the function of the handwriting pad, the user can easily use them without having to search for them one by one, thereby solving the problem of a tedious operation of finding and getting paper, a pen, and a calculator one by one during existing calculations. Finally, in the present embodiment, through the arrangement of the third clear switch 830, the content displayed on the third LCD screen 840 can be cleared during operation by the user, so that the user can use the calculator repeatedly.

In the embodiment where the calculator unit and the handwriting pad unit are integrated, the main body 800 is further provided with a third locking switch 870 electrically connected to the control module 850. The third locking switch 870 is configured to be operated by the user and generate a locking signal. The control module 850 is configured to receive the locking signal and lock the content displayed on the third LCD screen 840 according to the locking signal, so as to prevent the user from accidentally operating the third clear switch 830 to clear the content on the third LCD screen 840.

The third clear switch 830 can be a Hall switch. An end of the stylus pen 300 is provided with a magnetic field magnet 320 for generating a magnetic field. When detecting a magnetic field, the Hall switch generates a clear signal. The control module 850 can clear, according to the signal, the content displayed on the third LCD screen 840. Thus, the user can bring the end of the stylus pen 300 close to the Hall switch when the content on the third LCD screen 840 needs to be cleared. Certainly, in other embodiments, the third clear switch 830 may also be a switch button, a touch switch, a DIP switch, or the like.

In the embodiment where the calculator unit 100 and the handwriting pad unit 200 are integrated, a battery 180 is further arranged in the main body 800, and the control module 850 is electrically connected to the battery 180. The control module 850 is powered by the battery 180, which eliminates a cumbersome operation of connecting a power cable to an external power supply and facilitates portability for the user when going out.

In the embodiment where the calculator unit 100 and the handwriting pad unit 200 are integrated, the main body 800 is provided with a charging port electrically connected to the control module 850, so as to connect to an external power supply. The battery 180 is charged via the control module 850. Alternatively, in other embodiments, the battery 180 is detachably arranged on the main body 800, so that it is convenient to replace the battery 180 when the battery 180 is out of power.

In the embodiment where the calculator unit 100 and the handwriting pad unit 200 are integrated, the third key module 820 is located below the third display 810, and the third LCD screen 840 is located on a left side or right side of the third key module 820. The third clear switch 830 may be located below the third key module 820, or the third clear switch 830 may be located above, below, or on a left or right side of the third LCD screen 840. Certainly, in other embodiments, the third display 810 may also be located below the third key module 820, or above or below the third LCD screen 840, or at another position.

Specifically, in order to facilitate the production and manufacturing of the calculator in the present embodiment, the main body 800 includes a front housing 801 and a bottom housing 802. The bottom housing 802 is connected to the front housing 801 to form a cavity 880. The third key module 820, the third LCD screen 840, the third clear switch 830, and the third display 810 are all arranged in the front housing 801. The control module 850 is arranged in the cavity 880. The stylus pen 300 is detachably arranged in one of the front housing 801, the bottom housing 802, and the cavity 880.

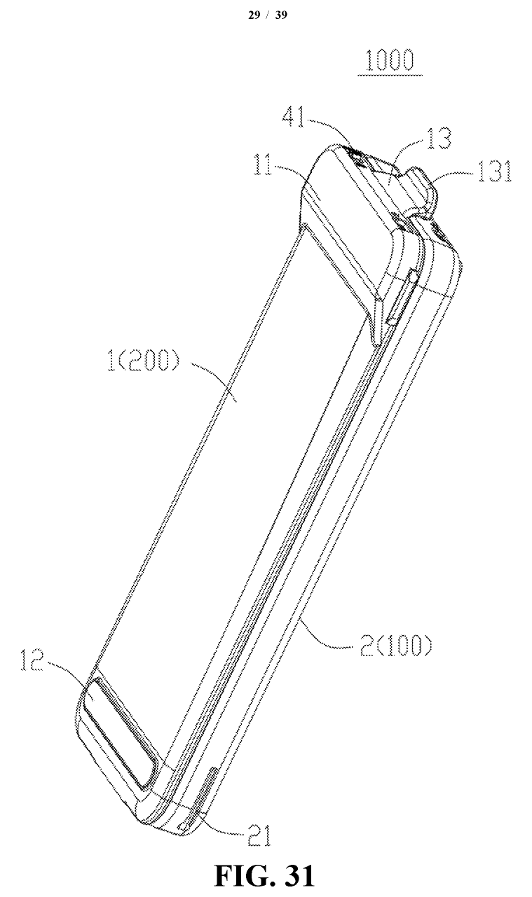

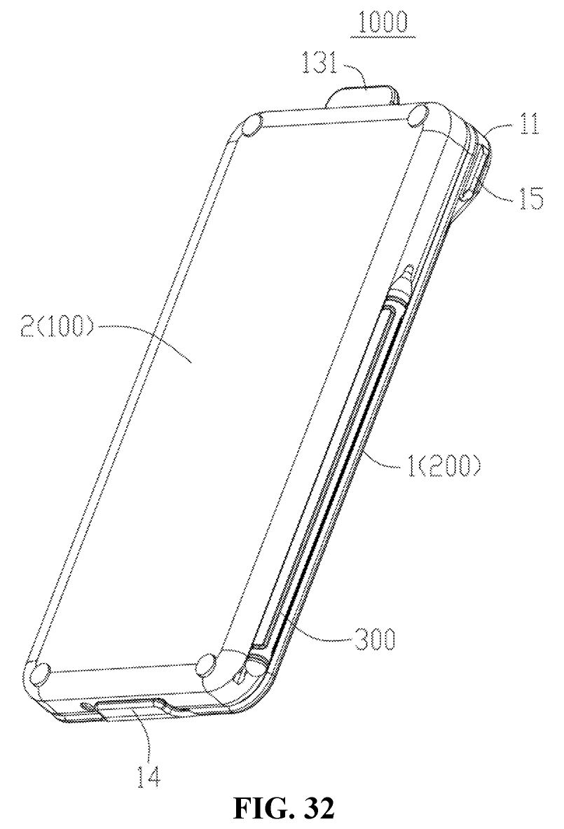

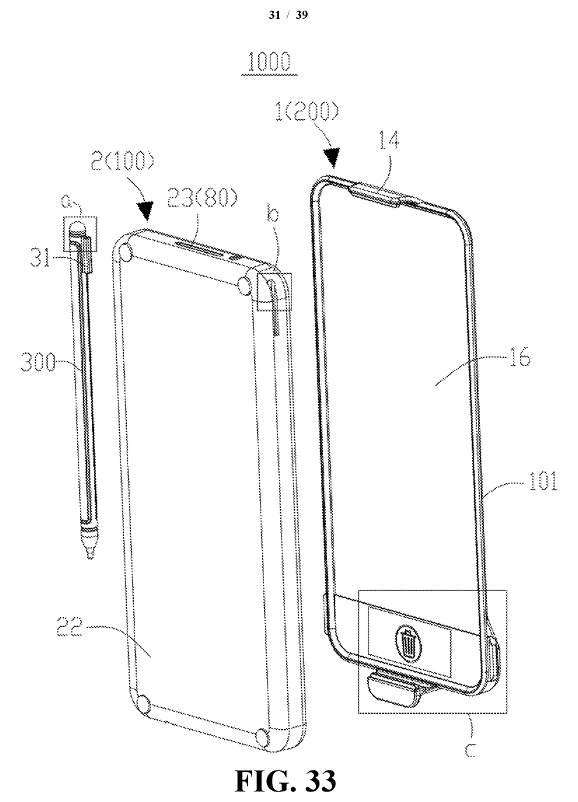

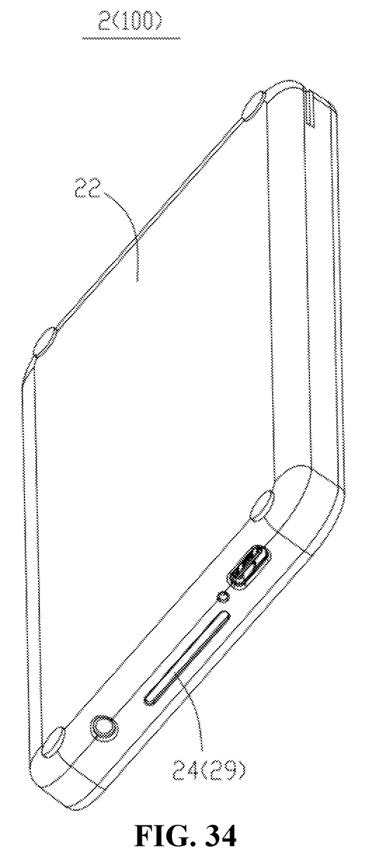

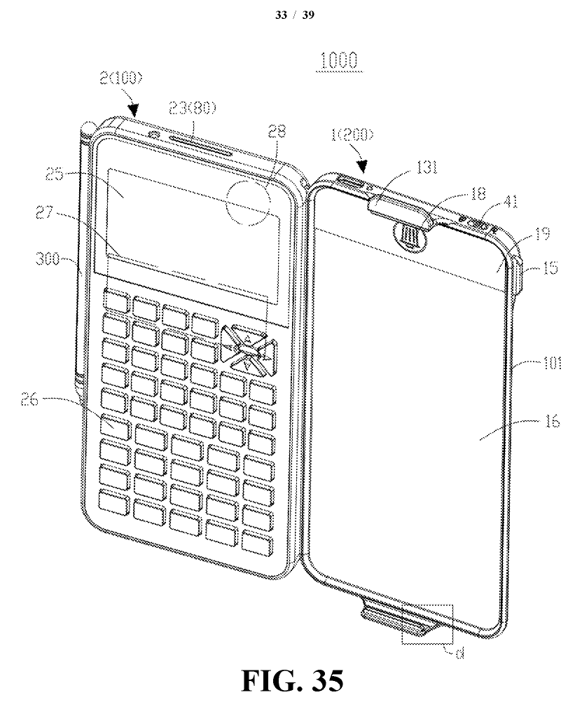

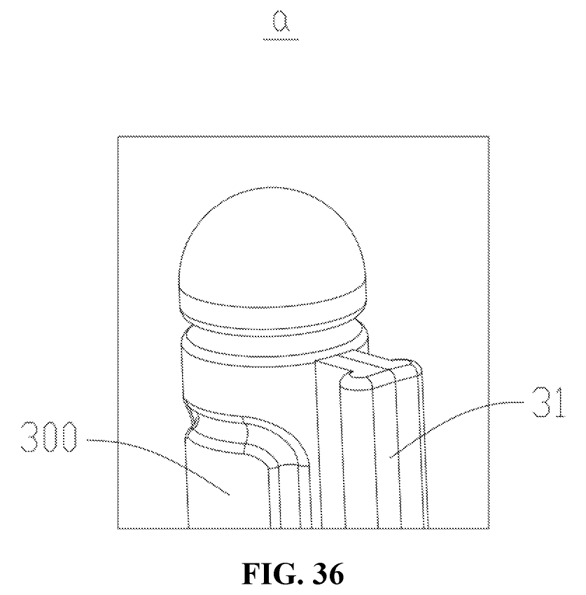

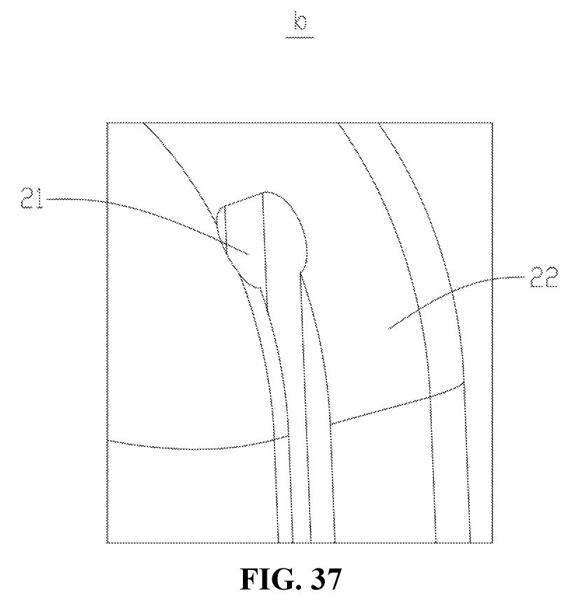

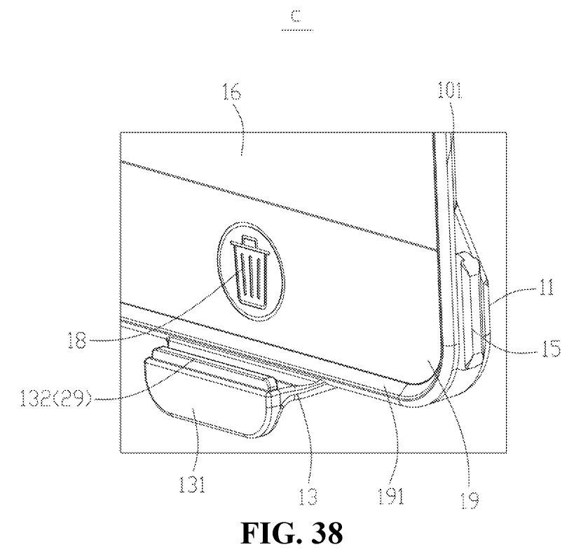

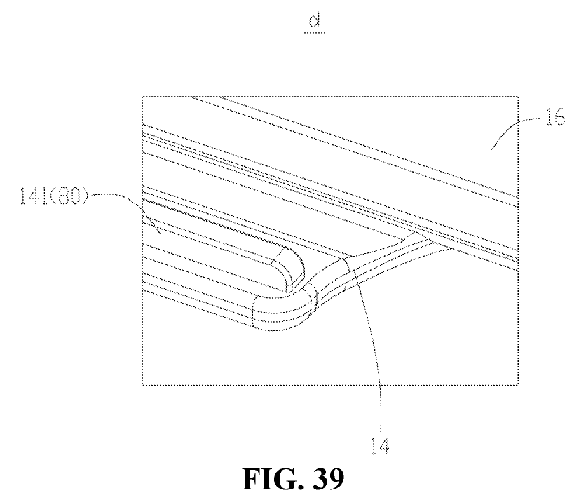

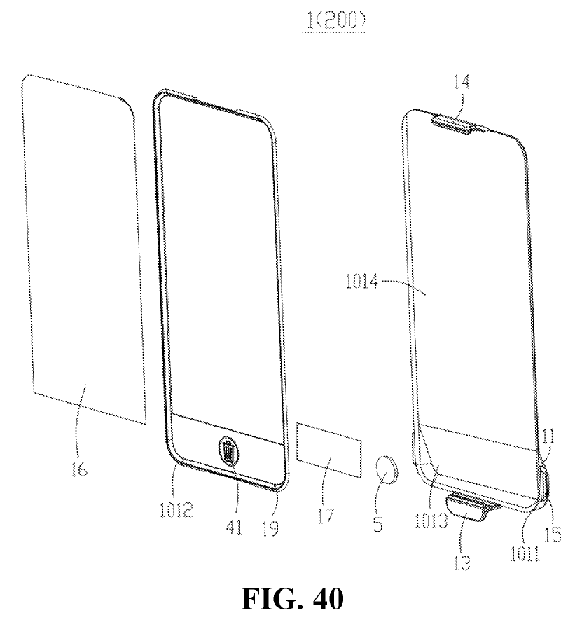

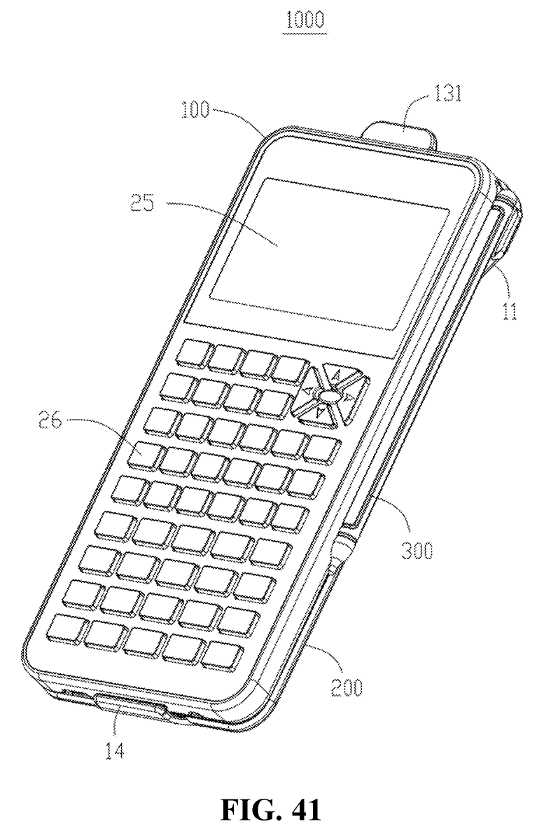

Referring to FIG. 31 - FIG. 41, another embodiment of the present disclosure provides a calculator 1000 with a handwriting pad.

The calculator 1000 with a handwriting pad includes a first device 1, a second device 2, and a stylus pen 300. The first device 1 is a handwriting pad unit 200, and the second device 2 is a calculator unit 100; alternatively, the first device 1 is a calculator unit 100, and the second device 2 is a handwriting pad unit 200.

The handwriting pad unit 200 and the calculator unit 100 are detachably connected. In a stored state, the handwriting pad unit 200 and the calculator unit 100 are arranged in an overlapped manner from up to down. In an unfolded state, a surface of the handwriting pad unit 200 is arranged horizontally side by side with the calculator unit 100.

The second device 2 is provided with hanging openings 21 on both sides or at positions adjacent to both sides of the second device. The first device 1 is provided with hanging members 15 adapted to the hanging openings 21 on both sides or at positions adjacent to both sides of the first device 1. When the hanging members 15 are arranged in the hanging openings 21, the first device 1 and the second device 2 are in a horizontally unfolded state.

The stylus pen 300 is adapted for use with the handwriting pad unit 200. The stylus pen 300 is provided with an adapting portion 31 adapted to the hanging opening 21 or the hanging member 15. The adapting portion 31 is a hanging opening 21, that is, the adapting portion 31 is adapted for use with the hanging member 15 on the first device 1. When the stylus pen 300 is not in use, the hanging member 15 can be arranged in the adapting portion 31 to store the stylus pen 300. When the stylus pen 300 is needed for use, the hanging member 15 is disengaged from the adapting portion 31. In other embodiments, the adapting portion 31 may also be a hanging member 15. That is, the adapting portion 31 may be adapted for use with the hanging opening 21 on the second device 2. When the stylus pen 300 is not in use, the hanging member 15 on the stylus pen 300 can be arranged in the hanging opening 21 to store the stylus pen 300. When the stylus pen 300 is needed for use, the hanging member 15 on the stylus pen 300 is disengaged from the hanging opening 21.

By providing the hanging member 15 and the hanging opening 21, when the hanging member 15 is arranged in the hanging opening 21, the first device 1 and the second device 2 are connected, that is, the calculator unit 100 and the handwriting pad unit 200 are connected, thereby preventing the calculator unit 100 and the handwriting pad unit 200 from separating during use. When a user needs to carry the calculator unit 100 or the handwriting pad unit 200 independently for use, the hanging member 15 can be disengaged from the hanging opening 21 to separate the calculator unit and the handwriting pad unit, thereby making it easier to carry the calculator unit 100 or the handwriting pad unit 200 for use. Moreover, according to the user’s writing habit, the user can connect the handwriting pad unit 200 to the left side or the right side of the calculator unit 100, so as to accommodate the usage needs of both right-handed and left-handed users, while preventing accidental pressing of the calculator unit 100 during use, thereby improving the user experience. For example, when the user writes with the right hand, the handwriting pad unit 200 can be connected to the right side of the calculator unit 100 by arranging the hanging member 15 in the hanging opening 21. When the user writes with the left hand, the handwriting pad unit 200 can be connected to the left side of the calculator unit 100 by arranging the hanging member 15 in the hanging opening 21.

Specifically, the hanging opening 21 has a C-shaped cross-section, and the hanging member 15 has a T-shaped cross-section. That is, the hanging member 15 and the hanging opening 21 can be connected in the form of a guide rail. Of course, in other embodiments, the cross-section of the hanging opening 21 may also be circular, square, polygonal, or irregular, and the cross-section of the hanging member 15 may have the same shape as that of the hanging opening 21. The hanging member 15 may be hook-shaped, for example, in the shape of the numeral 7, and the hanging member 15 is inserted into the hanging opening 21.

Continuing to refer to FIG. 31 - FIG. 41, the first device 1 is provided with a first receiving groove 19. When in a stored state, the second device 2 is at least partially received in the first receiving groove 19. A first engagement structure 29 is provided between the second device 2 and the first device 1. The first engagement structure 29 includes a first protruding block 132 and a first limiting groove 24 adapted to be engaged with the first protruding block 132. When the second device 2 is received in the first receiving groove 19, the first protruding block 132 is received in the first limiting groove 24. When stored, the first receiving groove 19 can limit the position of the second device 2, and the first engagement structure 29 is configured to fixedly connect the first device 1 and the second device 2, thereby preventing the second device 2 from detaching from the first device 1.

Specifically, a first connecting plate 13 and a second connecting plate 14 are arranged on the first device 1. The first connecting plate 13 and the second connecting plate 14 are arranged opposite to each other. The first connecting plate 13 and the second connecting plate 14 are distributed adjacent to the first receiving groove 19. A second engagement structure 80 is provided between the second connecting plate 14 and the second device 2. The second engagement structure 80 includes a second protruding block 141 and a second limiting groove 23 adapted to be engaged with the second protruding block 141. The second protruding block 141 is received in the second limiting groove 23 when the second device 2 is received in the first receiving groove 19.

By providing the first connecting plate 13 and the second connecting plate 14, when the second device 2 is received in the first receiving groove 19, the first connecting plate 13 and the second connecting plate 14 are distributed on two opposite sides of the second device 2. With the first protruding block 132 received in the first limiting groove 24 and the second protruding block 141 received in the second limiting groove 23, the second device 2 and the first device 1 are stably connected and fixed. This embodiment is applicable when the second device 2 is partially received in the first receiving groove 19.

Specifically, the first protruding block 132 is positioned on the first connecting plate 13, and the second protruding block 141 is positioned on the second connecting plate 14. The first limiting groove 24 and the second limiting groove 23 are provided on two opposite side walls of the second device 2. Alternatively, in other embodiments, the first limiting groove 24 is provided on the first connecting plate 13, and the second limiting groove 23 is provided on the second connecting plate 14. The first protruding block 132 and the second protruding block 141 are arranged on two opposite side walls of the second device 2.

In an embodiment where the second device 2 is completely received in the first receiving groove 19, the first connecting plate 13 and the second connecting plate 14 may be omitted. Instead, the first engagement structure and the second engagement structure may be provided between a side wall of the first receiving groove 19 and the second device 2, thereby also achieving a fixed connection between the second device 2 and the first device 1 when in a stored state.

In the embodiment where the first connecting plate 13 and the second connecting plate 14 are provided, a third protruding block 131 for use by a user is arranged on a side wall of the first connecting plate 13 away from the first receiving groove 19. The third protruding block 131 is positioned at an end portion of the first connecting plate 13 away from the first device 1. When the second device 2 needs to be taken out from the first receiving groove 19, by pulling the third protruding block 131, the end portion of the first connecting plate 13 away from the first device 1 can be deformed and moved away from the second device 2, so that the first protruding block 132 is disengaged from the first limiting groove 24. At this point, the second device 2 can be taken out from the first receiving groove 19.

In this embodiment, the first device 1 is a handwriting pad unit 200, and the second device 2 is a calculator unit 100.

The handwriting pad unit 200 includes a first hanging shell 101 and a hanging liquid crystal display (LCD) screen 16 provided on the first hanging shell 101. The hanging LCD screen 16 is positioned on a bottom surface of the first receiving groove 19. The first receiving groove 19 is defined and surrounded by the first hanging shell 101 and the hanging LCD screen 16. The first connecting plate 13 and the second connecting plate 14 are both arranged on the first hanging shell 101. Thus, when the second device 2 is received in the first receiving groove 19, the hanging LCD screen 16 is covered, thereby preventing the hanging LCD screen 16 from being exposed. As a result, the handwriting pad unit 200 serves as a protective cover, thereby protecting the hanging LCD screen 16. Furthermore, the surface of the calculator unit having the hanging key module 26 and the display 25 is received in the first receiving groove 19, so that during storage and carrying, the hanging key module 26 and the display 25 of the calculator unit 100 are protected from being bumped or scratched, thereby protecting the calculator unit 100. Moreover, this also can prevent the problem of accidental power-on caused by pressing the hanging key module 26.

In this embodiment, a depth of the first receiving groove 19 is in a range from 2 mm to 40 mm. This design prevents the depth of the first receiving groove 19 from being too deep, which would otherwise affect the user’s use of the hanging LCD screen 16. For example, the depth of the first receiving groove 19 may be 2 mm, 3 mm, 10 mm, 15 mm, or the like. Of course, in other embodiments, the depth of the first receiving groove 19 may also be 1.5 mm, 20 mm, 30 mm, 40 mm, or the like. The depth of the first receiving groove 19 may be determined according to the size of the handwriting pad unit 200 and the depth to which the calculator unit 100 is received in the first receiving groove 19. Therefore, the depth of the first receiving groove 19 is not limited herein.

At least one portion of a side wall of the first receiving groove 19 is a guiding surface 191. The guiding surface 191 may be an inclined surface or a curved surface. When the user uses the hanging LCD screen 16, the guiding surface 191 can prevent the side wall of the first receiving groove 19 from blocking the hanging LCD screen 16, thereby allowing the user to better observe the hanging LCD screen 16. Therefore, this effectively reduces the user’s visual blind spot with respect to the hanging LCD screen 16, enabling better use of the hanging LCD screen 16. Moreover, by providing the guiding surface 191, it is more convenient to arrange the second device 2 in the first receiving groove 19.

The handwriting pad unit 200 further includes a first hanging circuit board 17, a hanging clear switch 18, and a first hanging battery 5. The hanging clear switch 18 and the first hanging battery 5 are electrically connected to the first hanging circuit board 17. The first hanging circuit board 17 is further electrically connected to the hanging LCD screen 16. The first hanging battery 5 is configured for supplying power to the first hanging circuit board 17. When the user needs to clear content displayed on the hanging LCD screen 16, by operating the hanging clear switch 18, the first hanging circuit board 17 can receive an electrical signal from the hanging clear switch 18 and drive the hanging LCD screen 16 to clear the content. Specifically, the hanging clear switch 18 may be a mechanical button, a touch button, a Hall switch, or the like. The first hanging battery 5 may be a button battery, a rechargeable battery, or the like.

The handwriting pad unit 200 further includes a hanging lock switch 41. The hanging lock switch 41 is electrically connected to the first hanging circuit board 17 and is configured for operation by a user. When the user operates the hanging lock switch 41, the first hanging circuit board 17 is configured for locking or unlocking the content displayed on the hanging LCD screen 16.

The first hanging circuit board 17, the hanging lock switch 18, the hanging clear switch 41, and the first hanging battery 5 are all positioned on one side of the hanging LCD screen 16. The first hanging shell 101 is provided with a protruding clearance protrusion 11 at a position corresponding to the first hanging circuit board 17. The clearance protrusion 11 is arranged on a surface of the first hanging shell 101 facing away from the hanging LCD screen 16.

Specifically, the first hanging shell 101 includes a first hanging housing 1011 and a second hanging housing 1012. The second hanging housing 1012 is connected to the first hanging housing 1011 to form a second receiving groove 1014 and a third receiving groove 1013. The second receiving groove 1014 is located above the third receiving groove 1013. The hanging LCD screen 16 is arranged in the second receiving groove 1014. The first hanging battery 5 and the first hanging circuit board 17 are both arranged in the third receiving groove 1013. The clearance protrusion 11 is provided at a position corresponding to the third receiving groove 1013, and the third receiving groove 1013 has a depth greater than that of the second receiving groove 1014.

The second receiving groove 1014 is provided on the first hanging housing 1011. The hanging clear switch 18 and the hanging lock switch 41 are both arranged on the first hanging housing 1011. The first connecting plate 13 and the second connecting plate 14 are both arranged on the second hanging housing 1012.

A protective pad 12 is arranged on a surface of the first hanging shell 101 facing away from the hanging LCD screen 16. The protective pad 12 is provided at a position on the first hanging shell 101 away from the clearance protrusion 11. When the user uses the handwriting pad unit 200, the protective pad 12 provides anti-slip and cushioning support functions.

When the calculator unit 100 is in use, the handwriting pad unit 200 can also be reversely positioned on a back side of the calculator unit 100, and the back side of the calculator unit 100 is received in the first receiving groove 19. As shown in FIG. 41, the second protruding block 141 is received in the second limiting groove 23, and the first protruding block 132 is received in the first limiting groove 24. In cooperation with the clearance protrusion 11, one end of the calculator unit 100 can be raised, so that when placed on a flat surface for use, the calculator unit 100 can be placed in an inclined manner, thereby facilitating the user’s operation of the calculator unit 100.

The calculator unit 100 includes a second hanging shell 22, a second hanging circuit board 27, a second hanging battery 28, a hanging key module 26, and a hanging display 25. The second hanging circuit board 27 and the second hanging battery 28 are both arranged in the second hanging shell 22. The hanging key module 26 and the hanging display 25 are arranged on the second hanging shell 22. The second hanging battery 28, the hanging display 25, and the hanging key module 26 are each electrically connected to the second hanging circuit board 27. The hanging display 25 is located above the hanging key module 26. The second hanging battery 28 is configured for supplying power to the second hanging circuit board 27. When the hanging key module 26 is operated, data calculation is performed via the second hanging circuit board 27, and the calculated result is displayed on the hanging display 25. The second hanging battery 28 may be a button battery, a dry battery, a lithium battery, or the like.

In one embodiment, the hanging member 15 is positioned on a side wall of the first hanging shell 101, and the hanging opening 21 is provided on the second hanging shell 22 at a position adjacent to the hanging display 25. Alternatively, in other embodiments, when the first device 1 is the calculator unit 100, the hanging member 15 is arranged on the second hanging shell 22 at a position adjacent to the hanging display 25, and the hanging opening 21 is provided on the first hanging shell 101.

The above description only describes embodiments of the present disclosure, and is not intended to limit the present disclosure; various modifications and changes can be made to the present disclosure. Any modifications, equivalent substitutions, and improvements made within the spirit and scope of the present disclosure are intended to be included within the scope of the present disclosure.

1. A calculator with a handwriting pad, comprising a first device, a second device, and a stylus pen;
wherein the second device is provided with hanging openings on both side walls or at positions adjacent to both side walls of the second device, and the first device is provided with hanging members adapted to the hanging openings on both side walls or at positions adjacent to both side walls of the first device;
when the hanging members are arranged in the hanging openings, the first device and the second device are in a horizontally unfolded state;
the first device is one of a calculator unit and a handwriting pad unit, and the second device is the other of the calculator unit and the handwriting pad unit;
the stylus pen is adapted for use with the handwriting pad unit, the stylus pen is provided with an adapting portion adapted to the hanging opening or the hanging member, and the adapting portion is a hanging opening or a hanging member.

2. The calculator with a handwriting pad according to claim 1, wherein the hanging opening has a C-shaped cross-section, and the hanging member has a T-shaped cross-section.

3. The calculator with a handwriting pad according to claim 1, wherein the first device is provided with a first receiving groove;
when in a stored state, at least one portion of the second device is received in the first receiving groove.

4. The calculator with a handwriting pad according to claim 3, wherein a first engagement structure is arranged between the second device and the first device;
the first engagement structure comprises a first protruding block and a first limiting groove adapted to be engaged with the first protruding block, and the first protruding block is received in the first limiting groove when the second device is received in the first receiving groove.

5. The calculator with a handwriting pad according to claim 4, wherein a first connecting plate and a second connecting plate are arranged on the first device, the first connecting plate and the second connecting plate are distributed on two opposite sides of the first receiving groove, and the first engagement structure is provided between the first connecting plate and the second device;
a second engagement structure is provided between the second connecting plate and the second device, the second engagement structure comprises a second protruding block and a second limiting groove adapted to be engaged with the second protruding block, and the second protruding block is received in the second limiting groove when the second device is received in the first receiving groove.

6. The calculator with a handwriting pad according to claim 5, wherein the first connecting plate is provided, on a side wall facing away from the first receiving groove, with a third protruding block for use by a user, and the third protruding block is positioned at an end portion of the first connecting plate away from the first device.

7. The calculator with a handwriting pad according to claim 5, wherein the first protruding block is arranged on the first connecting plate, the second protruding block is arranged on the second connecting plate, and the first limiting groove and the second limiting groove are provided on two opposite side walls of the second device.

8. The calculator with a handwriting pad according to claim 5, wherein the first device is the handwriting pad unit, and the second device is the calculator unit;
the handwriting pad unit comprises a first hanging shell and a hanging liquid crystal display screen provided on the first hanging shell, the hanging liquid crystal display screen is positioned on a bottom surface of the first receiving groove, the first receiving groove is defined and surrounded by the first hanging shell and the liquid crystal display screen, the first connecting plate and the second connecting plate are both arranged on the first hanging shell, and a hanging key module is provided on a surface of the calculator unit;
when in a stored state, the hanging key module is received in the first receiving groove.

9. The calculator with a handwriting pad according to claim 6, wherein at least one portion of a side wall of the first receiving groove is a guiding surface, the guiding surface is an inclined surface or a curved surface, and a width of the first receiving groove gradually increases toward a position adjacent to the hanging liquid crystal display screen.

10. The calculator with a handwriting pad according to claim 6, wherein a depth of the first receiving groove is in a range from 2 mm to 40 mm.

11. The calculator with a handwriting pad according to claim 8, wherein when the calculator unit is in use, the handwriting pad unit is positioned on a back side of the calculator unit, the back side of the calculator unit is received in the first receiving groove, the second protruding block is received in the second limiting groove, and the first protruding block is received in the first limiting groove.

12. The calculator with a handwriting pad according to claim 11, wherein the first hanging shell is provided with a protruding clearance protrusion at a position adjacent to one end of the first hanging shell, and the clearance protrusion is arranged on one side of the first hanging shell away from the hanging liquid crystal display screen; when the back side of the calculator unit is received in the first receiving groove, the clearance protrusion is configured for raising one end of the calculator unit, so that the calculator unit is inclined when placed on a flat surface.

13. The calculator with a handwriting pad according to claim 8, wherein the handwriting pad unit further comprises a first hanging circuit board and a hanging clear switch electrically connected to the first hanging circuit board, the first hanging circuit board is arranged in the first hanging shell, the hanging clear switch is arranged on the first hanging shell, the hanging clear switch is configured for operation by a user, and when the user operates the hanging clear switch, the first hanging circuit board is configured to drive the hanging liquid crystal display screen to clear content displayed on the display screen.

14. The calculator with a handwriting pad according to claim 13, wherein the handwriting pad unit further comprises a hanging lock switch, the hanging lock switch is electrically connected to the first hanging circuit board, the hanging lock switch is configured for operation by a user, and when the user operates the hanging lock switch, the first hanging circuit board is configured for locking or unlocking content displayed on the hanging liquid crystal display screen.

15. The calculator with a handwriting pad according to claim 14, wherein the handwriting pad unit further comprises a first hanging battery, and the first hanging circuit board is further electrically connected to the first hanging battery.

16. The calculator with a handwriting pad according to claim 15, wherein the first hanging circuit board, the hanging lock switch, the hanging clear switch, and the first hanging battery are all positioned on one side of the hanging liquid crystal display screen, the first hanging shell is provided with a protruding clearance protrusion at a position corresponding to the first hanging circuit board, and the clearance protrusion is arranged on a surface of the first hanging shell facing away from the hanging liquid crystal display screen.

17. The calculator with a handwriting pad according to claim 16, wherein the first hanging shell comprises a first hanging housing and a second hanging housing, the second hanging housing is connected to the first hanging housing to form a second receiving groove and a third receiving groove, the second receiving groove is located above the third receiving groove, the hanging liquid crystal display screen is arranged in the second receiving groove, the first hanging battery and the first hanging circuit board are both arranged in the third receiving groove, the clearance protrusion is arranged at a position corresponding to the third receiving groove, and the third receiving groove has a depth greater than that of the second receiving groove;
the second receiving groove is provided on the first hanging housing, the hanging clear switch and the hanging lock switch are both arranged on the first hanging housing, and the first connecting plate and the second connecting plate are both arranged on the second hanging housing.

18. The calculator with a handwriting pad according to claim 16, wherein a protective pad is arranged on a surface of the first hanging shell facing away from the hanging liquid crystal display screen, and the protective pad is provided at a position on the first hanging shell away from the clearance protrusion.

19. The calculator with a handwriting pad according to claim 6, wherein the hanging member is positioned on a side wall of the first hanging shell;
the calculator unit comprises a second hanging shell, a second hanging circuit board, a second hanging battery, a hanging key module, and a hanging display, the second hanging circuit board and the second hanging battery are both arranged in the second hanging shell, the hanging key module and the hanging display are arranged on the second hanging shell, the hanging display is located above the hanging key module, and the hanging opening is provided on the second hanging shell at a position adjacent to the hanging display.
